(19) United States
(12) Patent Application Publication
(10) Pub. No.: US 2025/0136838 A1
(43) Pub. Date: May 1, 2025

(54) POLYCARBONATE-BASED POLYURETHANE TOPCOATS

(71) Applicant: PRC-Desoto International, Inc., Sylmar, CA (US)

(72) Inventors: Razmik Boghossian, Thousands Oaks, CA (US); James Smith, Santa Clarita, CA (US); Laxman Gurung, Los Angeles, CA (US); Renhe Lin, Santa Clarita, CA (US)

(73) Assignee: PRC-Desoto International, Inc., Sylmar, CA (US)

(21) Appl. No.: 18/834,678

(22) PCT Filed: Jan. 27, 2023
(86) PCT No.: PCT/US2023/061419

§ 371 Date: Jul. 31, 2024

Related U.S. Application Data
(60) Provisional application No. 63/305,418, filed on Feb. 1, 2022.

(51) Int. Cl. C09D 175/12; C08G 18/12; C08G 18/32

(52) U.S. Cl. CPC C09D 175/12; C08G 18/12; C08G 18/3228; C08G 18/3234

(57) ABSTRACT

Isocyanate-functional polyurethane prepolymers are prepared by reacting a polymeric diol, a non-linear short chain diol, a multifunctional polyol, and a diisocyanate. Coating compositions comprising the isocyanate-functional polyurethane prepolymers and a polyamine curing agent can be used to prepare topcoats that meet the demanding performance requirements of aerospace and other applications.

### FIELD

The disclosure relates to isocyanate-functional polyurethane prepolymers, coating compositions comprising the isocyanate-functional polyurethane prepolymers, and methods of using the coating compositions to provide polycarbonate-based polyurethane topcoats that meet the demanding performance requirements of aerospace and other applications.

### BACKGROUND

Topcoats for aerospace applications must meet demanding performance requirements including weatherability, long-term UV resistance, gloss retention, chemical resistance, high tensile strength, and percent elongation throughout a temperature range from −65° C. to 121° C. and maintain acceptable properties following solvent immersion at elevated temperature. In addition to meeting the performance requirements, it is desirable that sprayable coatings cure rapidly upon application to the surface of an aerospace vehicle.

### SUMMARY

According to the present invention isocyanate-functional polyurethane prepolymers comprise the reaction product of reactants comprising from 43 eq % to 63 eq % of a polymeric diol; from 26 eq % to 46 eq % of a non-linear short chain diol; from 6 eq % to 16 eq % of a multifunctional polyol; and a diisocyanate, wherein the diisocyanate comprises an aliphatic diisocyanate; wherein eq % is based on the total hydroxyl equivalents of the reactants.

According to the present invention isocyanate-functional polyurethane prepolymers comprise the reaction product of reactants comprising from 50 wt % to 70 wt % of a polymeric diol; from 1 wt % to 6 wt % of a non-linear short chain diol; from 1 wt % to 6 wt % of a multifunctional polyol; and from 25 wt % to 45 wt % of a diisocyanate, wherein the diisocyanate comprises an aliphatic diisocyanate; wherein wt % is based on the total weight of the reactants.

According to the present invention isocyanate functional polyurethane prepolymers have the structure of Formula (1) the structure of Formula (1a), or a combination thereof:

—P^{a}—(I^{a}—P^{a}-)ₙ (1)

I^{b}—P^{a}—(I^{a}—P^{a})ₙ—I^{b} (1a)
wherein,
   n is an integer from 1 to 50;
   each I^{a} and I^{b} is independently a moiety derived from a diisocyanate I;
   each polyol moiety P^{a} is independently selected from a moiety derived from a polymeric diol, a moiety derived from a non-linear short chain diol, and a moiety derived from a multifunctional polyol; wherein,
      from 46 mol % to 66 mol % of the moieties P^{a} are derived from the polymeric diol,
      from 4.8 mol % to 6.8 mol % of the moieties P^{a} are derived from the multifunctional polyol,
      from 28 mol % to 38 mol % of the moieties P^{a} are derived from the non-linear short chain diol, and
      mol % is based on the total moles of the moieties P^{a};
   the diisocyanate I has the structure of Formula (6):

O═C═N—R¹—N═C═O (6)
diisocyanate moiety I^{a} has the structure of Formula (6a):

—C(═O)—NH—R¹—NH—C(═O)— (6a)
diisocyanate moiety I^{b} has the structure of Formula (6b):

—C(═O)—NH—R¹—NH—N═C═O (6b)
each polyol moiety P^{a} is independently selected from a moiety having a structure of Formula (1a), a structure of Formula (3a), and a moiety derived from a polymeric diol:

—O—R²—O— (1a)

—O—B(—OH)_{z-2}—O— (3a)
wherein,
   z is an integer from 3 to 6;
   R¹ is selected from C₂₋₁₀ alkanediyl, C₂₋₁₀, heteroalkanediyl, C₅₋₁₂ cycloalkanediyl, C₅₋₁₂ heterocycloalkanediyl, C₆₋₂₀ arenediyl, C₅₋₂₀ heteroarenediyl, C₆₋₂₀ alkanecycloalkanediyl, C₆₋₂₀ heteroalkanecycloalkanediyl, C₇₋₂₀ alkanearenediyl, C₇₋₂₀ heteroalkanearenediyl, substituted C₂₋₁₀ alkanediyl, substituted C₂₋₁₀, heteroalkanediyl, substituted C₅₋₁₂ cycloalkanediyl, substituted C₅₋₁₂ heterocycloalkanediyl, substituted C₆₋₂₀ arenediyl, substituted C₅₋₂₀ heteroarenediyl, substituted C₆₋₂₀ alkanecycloalkanediyl, substituted C₆₋₂₀ heteroalkanecycloalkanediyl, substituted C₇₋₂₀ alkanearenediyl, and substituted C₇₋₂₀ heteroalkanearenediyl;
   R² is selected from —(C(R⁵)₂)ₛ— where s is an integer from 1 to 10; and
   each R⁵ is independently be selected from hydrogen and C₁₋₆ alkyl, and at least one R⁵ is C₁₋₆ alkyl; and
B is a core of a multifunctional polyol.

According to the present invention compositions comprise the isocyanate-functional polyurethane prepolymer of according to the present invention; and a curing agent, wherein the curing agent comprises a polyamine, a polyol, or a combination thereof.

According to the present invention coating systems comprise a first component, wherein the first component comprises the isocyanate-functional polyurethane prepolymer according to the present invention; and a second component, wherein the second component comprises a curing agent, wherein the curing agent comprises a polyamine, a polyol, or a combination thereof.

According to the present invention methods of coating a surface comprise applying a coating composition comprising the isocyanate-functional polyurethane prepolymer according to the present invention or the composition according to the present invention onto a substrate to provide an applied coating composition.

According to the present invention parts comprise a coating prepared from the composition according to the present invention or the coating system according to the present invention.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

“Formed from” or “prepared from” denotes open, e.g., comprising, claim language. As such, it is intended that a reaction product “formed from” or “prepared from” a list of recited components include the reaction product of at least the recited components, and can further comprise other, non-recited components used to form or prepare the reaction product.

“Reaction product of” means a chemical reaction product(s) of at least the recited reactants and can include partial reaction products as well as fully reacted products and other reaction products that are present in a lesser amount. For example, a “prepolymer comprising the reaction product of reactants” refers to a prepolymer or combination of prepolymers that are the reaction product of at least the recited reactants. The reactants can further comprise additional reactants.

As used herein, the term “cure” or “cured” as used in connection with a composition, e.g., “composition when cured” or a “cured composition”, means that any curable or crosslinkable components of the composition are at least partially reacted or crosslinked.

The term “equivalents” refers to the number of functional reactive groups of the substance. “Equivalent weight” is effectively equal to the molecular weight of a substance, divided by the valence or number of functional reactive groups of the substance.

A “backbone” of a prepolymer refers to the segment between the reactive terminal groups. A prepolymer backbone typically includes repeating subunits. For example, the backbone of a polythiol HS—(R)ₙ—SH is —(R)ₙ—.

A “core” of a polyfunctionalizing agent B(—V)_{z} refers to the moiety B. B can include the polyfunctionalizing agent with the terminal functional group V.

“Prepolymer” refers to oligomers, homopolymers, and copolymers. For thiol-terminated prepolymers, molecular weights are number average molecular weights “Mn” as determined by end group analysis using iodine titration, unless indicated otherwise. For prepolymers that are not thiol-terminated, the number average molecular weights are determined by gel permeation chromatography using polystyrene standards. A prepolymer comprises reactive groups capable of reacting with another compound such as a curing agent or crosslinker and/or another prepolymer to form a cured polymer. A prepolymer such as a chain-extended polythioether prepolymer provided by the present disclosure can be combined with a curing agent to provide a curable composition, which can cure to provide a cured polymer network. Prepolymers are liquid at room temperature (25° C.) and pressure (760 torr; 101 kPa).

A prepolymer includes multiple repeating subunits bonded to each other that can be the same or different. The multiple repeating subunits make up the backbone of the prepolymer.

“Prepolymer segment” refers to a moiety of a prepolymer backbone having a certain chemical structure and is generally derived from a particular reactant.

A “curable composition” refers to a composition that comprises at least two reactants capable of reacting to form a cured composition. For example, a curable composition can comprise an isocyanate-functional polyurethane prepolymer and a polyamine capable of reacting to form a cured polymer. A curable composition can include a catalyst for the curing reaction and other components such as, for example, fillers, pigments, and adhesion promoters. A curable composition can be curable at room temperature or may require exposure to elevated temperature such as a temperature above room temperature or other condition(s) to initiate and/or to accelerate the curing reaction. A curable composition may initially be provided as a two-part composition including, for example, a separate base component and an accelerator component. The base composition can contain one of the reactants participating in the curing reaction such as an isocyanate-functional polyurethane prepolymer and the accelerator component can contain the other reactant such as a polyamine. The two components can be mixed shortly before use to provide a curable composition. A curable composition can exhibit a viscosity suitable for a particular method of application. A coating system can further include a third component comprising primarily solvent. After the components of a coating system are combined and mixed, the curing reaction can proceed and the viscosity of the curable composition can increase and at some point, will no longer be workable, as described herein. The duration between the time when the components are mixed to form the curable composition and when the curable composition can no longer be reasonably or practically applied to a surface for its intended purpose can be referred to as the working time. As can be appreciated, the working time can depend on a number of factors including, for example, the curing chemistry, the catalyst used, the application method, and the temperature. After a curable composition is applied to a surface (and during application), the curing reaction can proceed to provide a cured composition. A cured composition develops a tack-free surface, cures, and then fully cures over a period of time. A curable composition can be considered to be cured when the hardness of the surface is at least 90% of the maximum hardness. After a sealant has cured to a hardness within 90% of the maximum hardness it can take from several days to several weeks for a curable composition fully cure. A composition is considered fully cured when the hardness no longer increases. Depending on the formulation, a fully cured sealant can exhibit, for example, a hardness from 40 Shore A to 70 Shore A, determined according to ISO 868. For coating applications, a curable composition can have a viscosity, for example, from 200 cps to 800 cps (0.2 Pa-sec to 0.8 Pa-sec) at 25° C. For sprayable coating and sealant compositions, a curable composition can have a viscosity, for example, from 15 cps to 100 cps (0.015 Pa-sec to 0.1 Pa-sec), such as from 20 cps to 80 cps (0.02 Pa-sec to 0.08 Pa-sec) at 25° C.

“Derived from the reaction of —V with an isocyanate” refers to a moiety —V′— resulting from the reaction of an isocyanate group with a moiety comprising a terminal group reactive with an isocyanate group. For example, a group V— can comprise HO—CH₂—O—, where the terminal hydroxyl group HO— is reactive with an isocyanate group ═N═C═O. Upon reaction with an isocyanate group, the moiety —V′—, which is derived from the reaction with the isocyanate group, is —O—CH₂—O—.

A “core” of a compound or a polymer refers to the segment between the reactive terminal groups. For example, the core of a diisocyanate O═N═C—R—N═C═O will be —R—. A core of a compound or prepolymer can also be referred to as a backbone of a compound or a backbone of a prepolymer. A core of a polyfunctionalizing agent can be an atom or a structure such as a cycloalkane radical, a substituted cycloalkane radical, heterocycloalkane radical, substituted heterocycloalkane radical, arene radical, substituted arene radical, heteroarene radical, or substituted heteroarene radical to which moieties having a reactive functional are bonded.

Specific gravity and density of compositions and sealants is determined according to ISO 2781.

Specific gravity and density of filler is determined according to ISO 787 (Part 10).

Shore A hardness is measured using a Type A durometer in accordance with ISO 868.

Tensile strength and elongation are measured according to ISO 37.

Glass transition temperature T_{g} is determined by dynamic mechanical analysis (DMA) using a TA Instruments Q800 apparatus with a frequency of 1 Hz, an amplitude of 20 microns, and a temperature ramp of −80° C. to 25° C., with the T_{g} identified as the peak of the tan δ curve.

Skydrol® is a fire-resistant hydraulic fluid based on phosphate ester chemistry. Skydrol® fluids include Skydrol® 500B-4, Skydrol® LD-4, Skydrol® 5, and Skydrol® PE-5, which are commercially available from Eastman Chemical Company.

When reference is made to a chemical group defined, for example, by a number of carbon atoms, the chemical group is intended to include all sub-ranges of carbon atoms as well as a specific number of carbon atoms. For example, a C₂₋₁₀ alkanediyl includes a C₂₋₄ alkanediyl, C₅₋₇ alkanediyl, and other sub-ranges, a C₂ alkanediyl, a C₆ alkanediyl, and alkanediyls having other specific number(s) of carbon atoms from 2 to 10, for example, 2, 3, 4, 5, 6, 7, 8, 9 or 10.

“Polyfunctionalizing agent” refers to a compound having a reactive functionality of three or more, such as from 3 to 6. A polyfunctionalizing agent can have three reactive functional groups and can be referred to as a trifunctionalizing agent. Polyfunctionalizing agents can be used as precursors for synthesizing the sulfur-containing prepolymers provided by the present disclosure and/or can be used as a reactant in the polymer curing composition to increase the crosslinking density of the cured polymer network. A polyfunctionalizing agent can have reactive terminal thiol groups, reactive terminal alkenyl groups, or a combination thereof. A polyfunctionalizing agent can have a calculated molecular weight, for example, less than 2,000 Daltons, less than 1,800 Daltons, less than 1,400 Daltons, less than 1,200 Daltons, less than 1,000 Daltons, less than 800 Daltons, less than 700 Daltons, less than 600 Daltons, less than 500 Daltons, less than 400 Daltons, less than 300 Daltons, or less than 200 Daltons. For example, a polyfunctionalizing agent can have a calculated molecular weight from 100 Daltons to 2,000 Daltons, from 200 Daltons to 2,000 Daltons, from 200 Daltons to 1,800 Daltons, from 300 Daltons to 1,500 Daltons, or from 300 Daltons to 1,000 Daltons. A calculated molecular weight refers to the weight of a compound based on the chemical structure of the compound.

“Polyol polyfunctionalizing agent” refers to a polyol having, for example, from 3 to 6 terminal hydroxyl groups. A polyol polyfunctionalizing agent can have a molecular weight, for example, less than 1,400 Daltons, less than 1,200 Daltons, less than 1,000 Daltons, less than 800 Daltons, less than 700 Daltons, less than 600 Daltons, less than 500 Daltons, less than 400 Daltons, less than 300 Daltons, less than 200 Daltons, or less than 100 Daltons. Polyol polyfunctionalizing agents can be represented by the formula B⁴(—V)_{z}, where B⁴ represents a core of a z-valent polyfunctionalizing agent B⁴(—V)_{z}, z is an integer from 3 to 6; and each —V is a moiety comprising a terminal hydroxyl (—OH) group.

“Composition” is intended to encompass a combination or mixture comprising the specified components in the specified amounts, as well as any product which results, directly or indirectly, from the combination of the specified ingredients in the specified amounts.

“A moiety derived from reaction with an isocyanate group” refers to a moiety produced by the reaction of a parent moiety with an isocyanate group. For example, a hydroxyl-terminated parent moiety having the structure —R—OH, upon reaction with a moiety having an isocyanate group —R—N═C═O, will produce the moiety —R—O—C(O)—NH—R— wherein the moieties —R—O—, and the moiety —R—NH—C(O)—, and —R—O—C(O)—NH—R— are said to be derived from reaction of the moiety —R—OH with the moiety having an isocyanate group —R—N═C═O. The moieties can also be referred to has being derived from the reaction of a hydroxyl group and an isocyanate group.

As used herein, the term “cure” or “cured” as used in connection with a composition, e.g., “composition when cured” or a “cured composition”, means that any curable or cross-linkable components of the composition are at least partially reacted or crosslinked.

“Molecular weight” refers to a theoretical molecular weight estimated from the chemical structure of a compound such as a monomeric compound, or a number average molecular weight as appropriate for a prepolymer determined, for example, using gel permeation chromatography using polystyrene standards, unless indicated otherwise.

A dash (“-”) that is not between two letters or symbols is used to indicate a point of covalent bonding for a substituent or between two atoms. For example, the chemical group —CONH₂ is covalently bonded to another chemical moiety through the carbon atom.

“Alkanearene” refers to a hydrocarbon group having one or more aryl and/or arenediyl groups and one or more alkyl and/or alkanediyl groups, where aryl, arenediyl, alkyl, and alkanediyl are defined herein. Each aryl and/or arenediyl group(s) can be C₆₋₁₂, C₆₋₁₀, phenyl or benzenediyl. Each alkyl and/or alkanediyl group(s) can be C₁₋₆, C₁₋₄, C₁₋₃, methyl, methanediyl, ethyl, or ethane-1,2-diyl. An alkanearene group can be C₄₋₁₈ alkanearene, C₄₋₁₆ alkanearene, C₄₋₁₂ alkanearene, C₄₋₈ alkanearene, C₆₋₁₂ alkanearene, C₆₋₁₀ alkanearene, or C₆₋₉ alkanearene. Examples of alkanearene groups include diphenyl methane.

“Alkanearenediyl” refers to a diradical of an alkanearene group. An alkanearenediyl group can be C₄₋₁₈ alkanearenediyl, C₄₋₁₆ alkanearenediyl, C₄₋₁₂ alkanearenediyl, C₄₋₈ alkanearenediyl, C₆₋₁₂ alkanearenediyl, C₆₋₁₀ alkanearenediyl, or C₆₋₉ alkanearenediyl. Examples of alkanearenediyl groups include diphenyl methane-4,4′-diyl.

“Alkanediyl” refers to a diradical of a saturated, branched or straight-chain, acyclic hydrocarbon group, having, for example, from 1 to 18 carbon atoms (C₁₋₁₈), from 1 to 14 carbon atoms (C₁₋₁₄), from 1 to 6 carbon atoms (C₁₋₆), from 1 to 4 carbon atoms (C₁₋₄), or from 1 to 3 hydrocarbon atoms (C₁₋₃). It will be appreciated that a branched alkanediyl has a minimum of three carbon atoms. An alkanediyl can be C₂₋₁₄ alkanediyl, C₂₋₁₀ alkanediyl, C₂₋₈ alkanediyl, C₂₋₆ alkanediyl, C₂₋₄ alkanediyl, or C₂₋₃ alkanediyl. Examples of alkanediyl groups include methane-diyl (—CH₂—), ethane-1,2-diyl (—CH₂CH₂—), propane-1,3-diyl and iso-propane-1,2-diyl (e.g., —CH₂CH₂CH₂— and —CH(CH₃)CH₂—), butane-1,4-diyl (—CH₂CH₂CH₂CH₂—), pentane-1,5-diyl (—CH₂CH₂CH₂CH₂CH₂—), hexane-1,6-diyl (—CH₂CH₂CH₂CH₂CH₂CH₂—), heptane-1,7-diyl, octane-1,8-diyl, nonane-1,9-diyl, decane-1,10-diyl, and dodecane-1,12-diyl.

“Alkanecycloalkane” refers to a saturated hydrocarbon group having one or more cycloalkyl and/or cycloalkanediyl groups and one or more alkyl and/or alkanediyl groups, where cycloalkyl, cycloalkanediyl, alkyl, and alkanediyl are defined herein. Each cycloalkyl and/or cycloalkanediyl group(s) can be C₃₋₆, C₅₋₆, cyclohexyl or cyclohexanediyl. Each alkyl and/or alkanediyl group(s) can be C₁₋₆, C₁₋₄, C₁₋₃, methyl, methanediyl, ethyl, or ethane-1,2-diyl. An alkanecycloalkane group can be C₄₋₁₈ alkanecycloalkane, C₄₋₁₆ alkanecycloalkane, C₄₋₁₂ alkanecycloalkane, C₄₋₈ alkanecycloalkane, C₆₋₁₂ alkanecycloalkane, C₆₋₁₀ alkanecycloalkane, or C₆₋₉ alkanecycloalkane. Examples of alkanecycloalkane groups include 1,1,3,3-tetramethylcyclohexane and cyclohexylmethane.

“Alkanecycloalkanediyl” refers to a diradical of an alkanecycloalkane group. An alkanecycloalkanediyl group can be C₄₋₁₈ alkanecycloalkanediyl, C₄₋₁₆ alkanecycloalkanediyl, C₄₋₁₂ alkanecycloalkanediyl, C₄₋₈ alkanecycloalkanediyl, C₆₋₁₂ alkanecycloalkanediyl, C₆₋₁₀ alkanecycloalkanediyl, or C₆₋₉ alkanecycloalkanediyl. Examples of alkanecycloalkanediyl groups include 1,1,3,3-tetramethylcyclohexane-1,5-diyl and cyclohexylmethane-4,4′-diyl.

“Alkyl” refers to a mono-radical of a saturated, branched or straight-chain, acyclic hydrocarbon group having, for example, from 1 to 20 carbon atoms, from 1 to 10 carbon atoms, from 1 to 6 carbon atoms, from 1 to 4 carbon atoms, or from 1 to 3 carbon atoms. It will be appreciated that a branched alkyl has a minimum of three carbon atoms. An alkyl group can be C₁₋₆ alkyl, C₁₋₄ alkyl, or C₁₋₃ alkyl. Examples of alkyl groups include methyl, ethyl, n-propyl, iso-propyl, n-butyl, iso-butyl, tert-butyl, n-hexyl, n-decyl, and tetradecyl. An alkyl group can be C₁₋₆ alkyl, C₁₋₄ alkyl, or C₁₋₃ alkyl. It will be appreciated that a branched alkyl has at least three carbon atoms.

“Cycloalkanediyl” refers to a diradical saturated monocyclic or polycyclic hydrocarbon group. A cycloalkanediyl group can be C₃₋₁₂ cycloalkanediyl, C₃₋₈ cycloalkanediyl, C₃₋₆ cycloalkanediyl, or, C₅₋₆ cycloalkanediyl. Examples of cycloalkanediyl groups include cyclohexane-1,4-diyl, cyclohexane-1,3-diyl, and cyclohexane-1,2-diyl.

“Cycloalkyl” refers to a saturated monocyclic or polycyclic hydrocarbon monoradical group. A cycloalkyl group can be, for example, C₃₋₁₂ cycloalkyl, C₃₋₈ cycloalkyl, C₃₋₆ cycloalkyl, or C₅₋₆ cycloalkyl.

“Heteroalkanediyl” refers to an alkanediyl group in which one or more of the carbon atoms are replaced with a heteroatom, such as N, O, S, or P. In a heteroalkanediyl, a heteroatom can be selected from N and O.

“Heteroalkanearenediyl” refers to an alkanearenediyl group in which one or more of the carbon atoms are replaced with a heteroatom, such as N, O, S, or P. In a heteroalkanearenediyl, a heteroatom can be selected from N and O.

“Heterocycloalkanediyl” refers to a cycloalkanediyl group in which one or more of the carbon atoms are replaced with a heteroatom, such as N, O, S, or P. In a heterocycloalkanediyl, a heteroatom can be selected from N and O.

“Polyol” refers to a compound having more than one reactive hydroxyl group. A polyol includes, for example, diols, triols, and tetraols. A polyol can include, for example, 2, 3, 4, 5, 6 hydroxyl groups or combinations of compounds having 2, 3, 4, 5, or 6 hydroxyl groups. A polyol can include a polymeric diol, a non-linear short chain diol, and a multifunctional polyol, where the multifunctional diol can have, for example from 3 to 6 hydroxyl groups.

“Substituted” refers to a group in which one or more hydrogen atoms are each independently replaced with the same or different substituent(s). A substituent can comprise halogen, —S(O)₂OH, —S(O)₂, —SH, —SR where R is C₁₋₆ alkyl, —COOH, —NO₂, —NR₂ where each R independently comprises hydrogen and C₁₋₃ alkyl, —CN, ═O, C₁₋₆ alkyl, —CF₃, —OH, phenyl, C₂₋₆ heteroalkyl, C₅₋₆ heteroaryl, C₁₋₆ alkoxy, or —C(O)R where R is C₁₋₆ alkyl. A substituent can be —OH, —NH₂, or C₁₋₃ alkyl.

Reference is now made to certain compounds, compositions, and methods of the present invention. The disclosed compounds, compositions, and methods are not intended to be limiting of the claims. To the contrary, the claims are intended to cover all alternatives, modifications, and equivalents.

Coating compositions provided by the present disclosure comprise an isocyanate-functional polyurethane prepolymer and a polyamine curing agent. The isocyanate-functional polyurethane prepolymers are prepared by reacting a polymeric polycarbonate diol, a non-linear short chain diol, a multifunctional polyol, and a diisocyanate. The coating compositions can be provided as sprayable two-component solvent-based polyurethane topcoat systems. Cured coatings prepared using the sprayable coating compositions exhibit excellent flexibility, chemical resistance, long-term UV stability and meet the demanding performance requirements for aerospace and other vehicles.

An isocyanate functional polyurethane prepolymer provided by the present disclosure can comprise the reaction product of reactants comprising a combination of polyols and a diisocyanate.

A polyol can comprise a polymeric diol, a non-linear short chain diol, and a multifunctional polyol.

A polymeric diol can comprise a polymeric polycarbonate diol or combination of polymeric polycarbonate diols. A polymeric polycarbonate diol can comprise a polymeric polycarbonate homopolymer diol, a polymeric polycarbonate copolymer diol, or a combination thereof.

A polymeric polycarbonate diol can have a number average molecular weight, for example, from 1,500 Daltons to 2,500 Daltons, such as from 1,700 Daltons to 2,300 Daltons, or from 1,900 Daltons to 2,100 Daltons. A polymeric polycarbonate diol can have a number average molecular weight, for example, greater than 1,500 Daltons, greater than 1,700 Daltons, greater than 1,900 Daltons, greater than 2,100 Daltons, or greater than 2,300 Daltons. A polymeric polycarbonate diol can have a number average molecular weight, for example, less than 2,500 Daltons, less than 2,300 Daltons, less than 2,100 Daltons, less than 1,900 Daltons, or less than 1,700 Daltons.

A polymeric diol can be liquid at room temperature such as 25° C. and 100 kPa.

A polymeric polycarbonate diol can be based on hexane diol, pentane diol, or a combination thereof.

A polymeric polycarbonate polyol can be produced by reacting a diol and a dialkyl carbonate. A polymeric polycarbonate polyol can include a polyhexamethylene carbonate such as HO—(CH₂)₆—[O—C(O)—O—(CH₂)₆]n-OH, where n can be an integer from 4 to 24, from 4 to 10, or from 5 to 7.

Examples of suitable polycarbonate polyols include aliphatic polycarbonate diols, for example those based upon alkylene glycols, ether glycols, alicyclic glycols or mixtures thereof. The alkylene groups for preparing the polycarbonate polyol can comprise from 5 to 10 carbon atoms and can be straight chain, cycloalkylene, or combinations thereof. Examples of suitable alkylene groups include hexylene, octylene, decylene, cyclohexylene and cyclohexyldimethylene. Suitable polycarbonate polyols can be prepared, for example, by reacting a hydroxy terminated alkylene glycol with a dialkyl carbonate, such as methyl, ethyl, n-propyl or n-butyl carbonate, or diaryl carbonate, such as diphenyl or dinaphthyl carbonate, or by reacting of a hydroxyl-terminated alkylene diol with phosgene or bischloroformate, in a manner well-known to those skilled in the art. Examples of such polycarbonate polyols include those commercially available as Ravecarb™ 107 from Enichem S.p.A. (Polimeri Europa), and polyhexylene carbonate diols, 1,000 number average molecular weight, such as 13410-1733 polycarbonate diol prepared from hexanediol, available from Stahl. Examples of other suitable polycarbonate polyols that are commercially available include KM10-1122, KM10-1667 (prepared from a 50/50 weight percent mixture of cyclohexane dimethanol and hexanediol) (commercially available from Stahl U.S.A. Inc.) and Desmophen® 2020E (Bayer Corp.).

Examples of suitable polymeric polycarbonate diols include Eternacoll® polyols (available form UBE), Desmophen® polycarbonate diols (available from Covestro), Kuraray® polyols (available form Kuraray Group) and Placell® polycarbonate polyols (available from KH Neochem).

A polycarbonate copolymer diol can comprise a polycarbonate/PTMEG (polytetramethylene ether glycol) copolymer diol, a polycarbonate/polycaprolactone copolymer diol, a polycarbonate/polyester copolymer diol, or a combination of any of the foregoing.

Reactants for preparing an isocyanate-functional polyurethane prepolymer provided by the present disclosure can comprise, for example, from 82 wt % to 98 wt %, from 84 wt % to 96 wt % such as from 86 wt % to 94 wt % of a polymeric polycarbonate diol or combination of polymeric polycarbonate diols, where wt % is based on the total weight of the polyols in the reactants.

Reactants can comprise, for example, from 50 wt % to 70 wt % such as from 55 wt % to 65 wt % of a polymeric polycarbonate diol or combination of polymeric polycarbonate diols, where wt % is based on the total weight of the reactants.

Reactants can comprise, for example, from 43 eq % to 63 eq % such as from 48 eq % to 68 eq % of a polymeric polycarbonate diol or combination of polymeric polycarbonate diols, wherein eq % is based on the total hydroxyl equivalents in the reactants.

Reactants can comprise, for example, from 46 mol % to 66 mol % such as from 51 mol % to 61 mol % of a polymeric polycarbonate diol or combination of polymeric polycarbonate diols, wherein mol % is based on the total moles of the polyol in the reactants.

Reactants can comprise, for example, from 6 mol % to 26 mol %, from 8 mol % to 24 mol %, from 10 mol % to 22 mol %, or from 12 mol % to 20 mol % of a polymeric polycarbonate diol or combination of polymeric polycarbonate diols, wherein mol % is based on the total moles of hydroxyl and isocyanate groups in the reactants.

A polymeric polycarbonate diol can have a number average molecular weight, for example, from 1,000 Da to 3,000 Da, from 1,200 Da to 2,800 Da, from 1,400 Da to 2,600 Da, from 1,600 Da to 2,400 Da, or from 1,800 Da to 2,200 Da, where the molecular weight is determined using gel permeation chromatography.

A polymeric polycarbonate polyol can have a hydroxyl value, for example, from 40 mg KOH/g to 70 mg KOH/g, from 45 mg KOH/g to 65 mg KOH/g, or from 50 mg KOH/g to 60 mg KOH/g, wherein the hydroxyl value is measured by titrating a known mass of polyol against potassium hydroxide (KOH), and is expressed as mg KOH/g. Lower hydroxyl values indicate lower hydroxyl content and a higher molecular weight for the overall polymeric polycarbonate diol.

A polymeric polycarbonate diol can have an OH equivalent weight, for example, from 600 Da to 1,400 Da, from 700 Da to 1,300 Da, from 800 to 1,200 Da, or from 900 Da to 1,100 Da.

A non-linear short chain diol can comprise a branched diol, a cyclic diol, or a combination thereof.

A non-linear short-chain diol includes branched short chain diols and cyclic diols. In a branched short-chain diol, one or more of the methane-diyl groups comprises one or two substituent groups, which can be expressed, for example, as —CH(—R)— and —C(R)₂—, where R represents a substituent group. A substituent group can be a C₁₋₄ alkyl group such as methyl, ethyl, n-propyl, isopropyl, n-butyl, and iso-butyl. A non-linear short-chain diol can also include cyclic diols in which the group linking the two hydroxyl groups comprises a cyclic organic moiety. A short-chain diol can have a molecular weight, for example, less than 500 Daltons, less than 400 Daltons, less than 300 Daltons, less than 200 Daltons, or less than 100 Daltons. A short-chain diol including linear and non-linear short-chain diols can have a molecular weight, for example, from 50 Daltons to 500 Daltons, from 50 Daltons to 400 Daltons, from 50 Daltons to 300 Daltons, or from 50 Daltons to 200 Daltons. When a moiety derived from a non-linear short-chain diol is incorporated into a prepolymer backbone, it is believed that the non-linear segments within the prepolymer backbone can increase the free volume within the cured polymer matrix, thereby providing free volume for molecular motion. The molecules can orient and rotate into configurations and alignments having favorable energy states that can provide enhanced impact properties and/or high modulus of elasticity for the cured polymer matrix.

Suitable non-linear short-chain diols can comprise moieties that reduce hydrogen bonding in the cured polymer and increase the entropy of the cured composition. Non-linear chain-short chain diols can include lower molecular weight non-linear short chain diols and can have, for example, a molecular weight within a range from 100 Daltons to 500 Daltons, from 100 Daltons to 300 Daltons, or from 100 Daltons to 200 Daltons.

Suitable branched short chain diols can comprise at least one branching or pendent group and can have a molecular weight of, for example, less than 200 Daltons, less than 300 Daltons, less than 400 Daltons, or less than 500 Daltons, determined by gel permeation chromatography using a polystyrene standard.

Suitable non-linear short-chain diols include branched short-chain diols, cyclic diols, and a combination thereof.

A branched short-chain diol can comprise, for example, from 2 to 10 carbon atoms in the chain connecting the two hydroxy groups and from 1 to 4 pendent groups attached thereto. Each of the pendent branching groups can comprise, for example, from 1 to 4 carbon atoms, so that in this example the branched short-chain diol can comprise from 3 to 24 carbon atoms in total. A branched short-chain diol can comprise a branched short-chain diol of Formula (1):

HO—R²—OH (1)

where R² is —(C(R⁵)₂)ₛ— where s can be an integer from 1 to 10; each R⁵ can independently be selected from hydrogen and C₁₋₆ alkyl, and at least one R can be C₁₋₆ alkyl.

In a non-linear short-chain diol of Formula (1), s can be an integer from 3 to 6, or can be 1, 2, 3, 4, 5, 6, 7, 8, 9, or 10. In a branched short-chain diol of Formula (1), at least one R⁵ can be C₁₋₆ alkyl, or at least two R can be C₁₋₆ alkyl. In a branched short-chain diol of Formula (1), each R⁵ can be independently selected from hydrogen, methyl, ethyl, n-propyl, isopropyl, n-butyl, iso-butyl, and tert-butyl.

Examples of suitable branched short chain diols include 2-ethyl-1,3-hexane diol, 2-butyl-2-ethyl-1,3-propanediol, 2,4-diethyl-1,5-pentanediol (PD-9), 3-methyl-1,5-pentanediol, 2-ethyl-1-methyl-1,5-pentanediol, 3-tert.-butyl-1,5-pentanediol, 2-methyl-2,4-pentanediol, 3,3-dimethoxy-1,5-pentanediol, neopentyl glycol, 2,2-diethyl-1,3-propanediol, 2,2,4-trimethyl-1,3-pentanediol, 2,2-dibutyl-1,3-propanediol, 2,2-methyl-2,3-pentanediol, 3,3-dimethyl-1,2-butanediol, 3-ethyl-1,3-pentanediol, 2-butyl-1,3-propanediol, and combinations of any of the foregoing.

Additional examples of suitable branched short-chain diols include branched chain alkane diols, such as propylene glycol, neopentyl glycol, 2-methyl-butanediol, 2,2,4-trimethyl-1,3-pentanediol, 2-methyl-1,3-pentanediol, 2-ethyl-1,3-hexanediol, 2-methyl-1,3-propanediol, 2,2-dimethyl-1,3-propanediol, dibutyl 1,3-propanediol, 2-ethyl-1,3-hexane diol, 2-butyl-2-ethyl-1,3-propanediol, 1,4-cyclohexane di-methanol, 2,4-diethyl-1,5-pentanediol, 3-methyl-1,5-pentanediol, 2-ethyl-1-methyl-1,5-pentanediol, 3-tert-butyl-1,5-pentanediol, 2-methyl-2,4-pentanediol, 2,2-diethyl-1,3-propanediol, 2,2,4-trimethyl-1,3-pentanediol, 2,2-dibutyl-1,3-propanediol, 2,2-methyl-2,3-pentanediol, 3,3-dimethyl-1,2-butanediol, 3-ethyl-1,3-pentanediol, 2-butyl-1,3-propanediol, 2-butyl-2-ethyl-1,3-propanediol, and combinations of any of the foregoing.

Other examples of branched short-chain diols include branched propylene glycols such as dipropylene glycol, tripropylene glycol, and 3,3-dimethoxy-1,5-pentanediol. A branched propylene glycol can have the structure H—(—O—CH(—CH₃)—CH₂—)ₙ—OH where n can be, for example, from 1 to 20.

A non-linear short-chain diol can comprise a cyclic diol. A cyclic diol can comprise a cyclic diol of Formula (2):

HO—R⁶—OH (2)

where R⁶ can be selected from C₅₋₁₀ cycloalkanediyl, C₆₋₁₈ alkanecycloalkanediyl, C₅₋₁₀ heterocycloalkanediyl, C₆₋₁₈ heteroalkanecycloalkanediyl, substituted C₅₋₁₀ cycloalkanediyl, substituted C₆₋₁₈ alkanecycloalkanediyl, substituted C₅₋₁₀ heterocycloalkanediyl, and substituted C₆₋₁₈ heteroalkanecycloalkanediyl.

Examples of suitable cyclic diols include, 2,2′-(cyclohexane-1,1-diyl)-diethanol, 4,4′-bicyclohexanol, 4,8-bis(hydroxymethyl)tricyclo[5.2.1]decane, 2,2,4,4-tetramethyl-1,8-cyclobutanediol, cyclopentanediol, 1,4-cyclohexanediol, cyclohexanedimethanols (CHDM), 1,4-cyclohexane di-methanol, 1,2-cyclohexane di-methanol, and 1,3-cyclohexane di-methanol; cyclododecanediol, 4,4′-isopropylidene-bicyclohexanol, hydroxypropylcyclohexanol, cyclohexanediethanol, 1,2-bis(hydroxymethyl)-cyclohexane, 1,2-bis(hydroxyethyl)-cyclohexane, 4,4′-isopropylidene-biscyclohexanol, bis(4-hydroxycyclohexanol)methane, and combinations of any of the foregoing.

Reactants for preparing an isocyanate-functional polyurethane prepolymer can comprise, for example, from 1 wt % to 9 wt % of a non-linear short chain diol or combination of non-linear short chain diols, from 2 wt % to 8 wt %, from 3 wt % to 7 wt %, or from 4 wt % to 6 wt % of a non-linear short chain diol or combination of non-linear short chain diols, where wt % is based on the total weight of the polyol in the reactants.

Reactants for preparing a polymeric polycarbonate diol can comprise, for example, from 1 wt % to 7 wt % of a non-linear short chain diol or combination of non-linear short chain diols, from 2.5 wt % to 6.5 wt %, from 3 wt % to 6 wt %, from 3.5 wt % to 5.5 wt %, or from 3 wt % to 5 wt % of a non-linear short chain diol or combination of non-linear short chain diols, where wt % is based on the total weight of the reactants.

Reactants can comprise, for example, from 26 eq % to 46 eq % of a non-linear short chain diol or combination of non-linear short chain diols, from 28 eq % to 44 eq %, from 30 eq % to 42 eq %, from 32 eq % to 40 eq %, or from 34 eq % to 38 eq % of a non-linear short chain diol or combination of non-linear short chain diols, wherein eq % is based on the total hydroxyl equivalents in the reactants.

Reactants can comprise, for example, from 28 mol % to 48 mol % of a non-linear diol or combination of non-linear short chain diols, from 30 mol % to 46 mol %, from 32 mol % to 44 mol %, from 34 mol % to 42 mol %, from 36 mol % to 40 mol % of a non-linear short chain diol or combination of non-linear short chain diols, wherein mol % is based on the total moles of the reactants.

Reactants can comprise, for example, from 6 mol % to 16 mol %, from 8 mol % to 14 mol %, or from 10 mol % to 12 mol % of a non-linear diol or combination of non-linear diols, wherein mol % is based on the total moles of the reactants.

A polyol can comprise a multifunctional polyol or combination of multifunctional polyols.

A multifunctional polyol can have an average hydroxyl functionality, for example, from 3 to 6, from 3 to 5 or from 3 to 4. A multifunctional polyol can have a hydroxyl functionality, for example, of 3, 4, 5, or 6. A multifunctional polyol can have a hydroxyl functionality of 4.

A multifunctional polyol can comprise a polymeric multifunctional polycaprolactone polyol.

A multifunctional polyol can have a molecular weight, for example, from 100 Daltons to 2,000 Daltons, from 100 Daltons to 1,500 Daltons, from 100 Daltons to 1,000 Daltons, from 100 Daltons to 500 Daltons, from 500 Daltons to 2,000 Daltons, from 500 Daltons to 1,500 Daltons, from 700 Daltons to 1,300 Daltons, or from 900 Daltons to 1,000 Daltons. A multifunctional polyol can have a molecular weight, for example, greater than 100 Daltons, greater than 500 Daltons, greater than 700 Daltons, greater than 900 Daltons, greater than 1,000 Daltons, greater than 1,300 Daltons, or greater than 1,500 Daltons. A multifunctional polyol can have a molecular weight, for example, less than 2,000 Daltons, less than 1,500 Daltons, less than 1,300 Daltons, less than 1,100 Daltons, less than 900 Daltons, less than 700 Daltons, or less than 500 Daltons.

A multifunctional polyol can comprise a multifunctional polyol of Formula (3):

B(—OH)_{z} (3)

where z is an integer from 3 to 6; and B is a core of the multifunctional polyol.

In a multifunctional polyol of Formula (3), z can be 3, 4, 5, or 6.

Examples of suitable trifunctional, tetrafunctional or higher polyols include branched chain alkane polyols such as glycerol or glycerin, tetramethylolmethane, trimethylolethane (for example 1,1,1-trimethylolethane), trimethylolpropane (TMP) (for example 1,1,1-trimethylolpropane), erythritol, pentaerythritol, dipentaerythritol, tripentaerythritol, sorbitan, alkoxylated derivatives thereof, and combinations of any of the foregoing. A polyol can be a cycloalkane polyol, such as trimethylene bis(1,3,5-cyclohexanetriol). A polyol can be an aromatic polyol, such as trimethylene bis(1,3,5-benzenetriol). Examples of other suitable polyols include polyols which can be alkoxylated derivatives, such as ethoxylated, propoxylated and butoxylated. A suitable polyol can be alkoxylated with from 1 to 10 alkoxy groups: glycerol, trimethylolethane, trimethylolpropane, benzenetriol, cyclohexanetriol, erythritol, pentaerythritol, sorbitol, mannitol, sorbitan, dipentaerythritol and tripentaerythritol. Alkoxylated, ethoxylated and propoxylated polyols and combinations thereof can be used alone or in combination with unalkoxylated, unethoxylated and unpropoxylated polyols having at least three hydroxyl groups and mixtures thereof. The number of alkoxy groups can be from 1 to 10, or from 2 to 8 or any rational number between 1 and 10. An alkoxy group can be ethoxy and the number of ethoxy groups can be 1 to 5 units. A polyol can be trimethylolpropane having up to 2 ethoxy groups. Suitable alkoxylated polyols include ethoxylated trimethylolpropane, propoxylated trimethylolpropane, ethoxylated trimethylolethane, and combinations of any of the foregoing.

Examples of suitable trifunctional, tetrafunctional, or higher polyols include alkane polyols, such as glycerol, glycerin, tetramethylolmethane, trimethylolethane (for example 1,1,1-trimethylolethane), trimethylolpropane (TMP) (for example 1,1,1-trimethylolpropane), erythritol, pentaerythritol, dipentaerythritol, tripentaerythritol, sorbitan, alkoxylated derivatives thereof, and combinations of any of the foregoing.

A multifunctional polyol can comprise a cycloalkane polyol, such as trimethylene bis(1,3,5-cyclohexanetriol).

A multifunctional polyol can comprise an aromatic polyol, such as trimethylene bis(1,3,5-benzenetriol).

A multifunctional polyol can include polycaprolactones, such as CAPA® polycaprolactones such as CAPA® 4101 (2-oxepanone, polymer with 2,2-bis(hydroxymethyl)-1,3-propanediol), CAPA® 3031 (2-oxepanone, polymer with 2-ethyl-2-(hydroxymethyl)-1,3-propanediol), and CAPA® 4101 (polycaprolactone polyol tetrol) available from Perstorp Group. Such caprolactone polyols include tri- and tetra-functional polyols having a number average molecular weight from 300 Daltons to 8,000 Daltons.

A multifunctional polyol can comprise a polycaprolactone polyol. A polycaprolactone polyol can have a number average molecular weight from 500 Daltons to 2,000 Daltons. A polycaprolactone polyol can have a hydroxyl functionality of from 3 to 6 such as a hydroxyl functionality fo 4. A polycaprolactone polyol can have a OH value of 218 mg KOH/mg and an acid value<1.0 mg KOH/g. A polycaprolactone polyol can have the structure C{—CH₂—O—(C(O)—(CH₂)ₘ—O—)ₙ—H}₄ wherein each m is independently an integer from 2 to 10; and each n is independently an integer from 1 to 4. In a polycaprolactone polyol having the structure C{—CH₂—O—(C(O)—(CH₂)ₘ—O—)ₙ—H}₄ each m can be 5 and each n can independently be an integer from 1 to 3.

A multifunctional polyol can comprise a multifunctional polyol of Formula (4a), a polyol of Formula (4b), or a combination thereof:

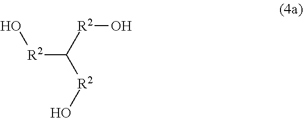

where each R² is independently C₁₋₆ alkanediyl;

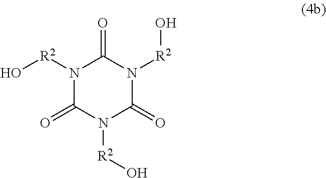

where each R² is independently C₁₋₆ alkanediyl. Accordingly, in these multifunctional polyols the core has the structure of Formula (4c) or Formula (4d), respectively:

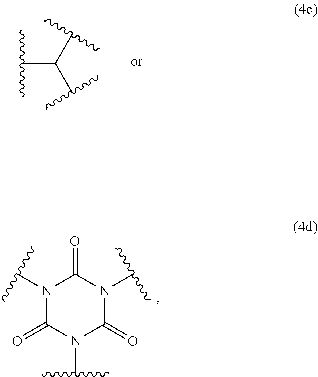

where each R² is independently C₁₋₆ alkanediyl.

Reactants can comprise, for example, from 1 wt % to 9 wt %, from 2 wt % to 8 wt %, from 3 wt % to 7 wt %, or from 4 wt % to 6 wt % of a multifunctional polyol or combination of multifunctional polyols, where wt % is based on the total weight of the polyol in the reactants.

Reactants can comprise, for example, from 1 wt % to 5 wt %, from 1.5 wt % to 4.5 wt %, from 2 wt % to 4 wt %, or from 2.5 wt % to 3.5 wt % of a multifunctional polyol or combination of multifunctional polyols, where wt % is based on the total weight of the reactants.

Reactants can comprise, for example, from 6 eq % to 16 eq % of a multifunctional polyol or combination of multifunctional polyols, from 7 eq % to 15 eq %, from 8 eq % to 14 eq %, from 9 eq % to 13 eq %, or from 10 eq % to 12 eq % of a multifunctional polyol or combination of multifunctional polyols, where eq % is based on the total hydroxyl equivalents in the reactants.

Reactants can comprise, for example, from 2 mol % to 10 mol % of a multifunctional polyol or combination of multifunctional polyols, from 3 mol % to 9 mol %, from 4 mol % to 8 mol %, or from 5 mol % to 7 mol % of a multifunctional polyol or combination of multifunctional polyols, where mol % is based on the total moles of polyol in the reactants.

Reactants can comprise, for example, from 0.5 mol % to 3.5 mol %, from 1 mol % to 3 mol %, or from 1.5 mol % to 2.5 mol % of a multifunctional polyol or combination of multifunctional polyols, where mol % is based on the total moles of the reactants.

A polyol used to prepare an isocyanate-functional polyurethane prepolymer provided by the present disclosure can comprise a polymeric diol, a non-linear short chain diol, and a multifunctional polyol.

A polyol used to prepare a polyurethane prepolymer provided by the present disclosure can comprise, for example,
from 85 wt % to 95 wt % of a polymeric diol;
from 2 wt % to 8 wt % of a non-linear short chain diol; and
from 2 wt % to 8 wt % of a multifunctional polyol,
where wt % is based on the total weight of the polyol in the reactants.

A polyol used to prepare a polyurethane prepolymer provided by the present disclosure can comprise, for example,
from 46 mol % to 66 mol % of a polymeric diol;
from 28 mol % to 48 mol % of a non-linear short chain diol; and
from 2 mol % to 10 mol % of a multifunctional polyol,
where mol % is based on the total moles of the polyol in the reactants.

A polyol used to prepare a polyurethane prepolymer provided by the present disclosure can comprise, for example,
from 43 eq % to 63 eq % of a polymeric diol;
from 26 eq % to 46 eq % of a non-linear diol; and
from 6 eq % to 16 eq % of a multifunctional polyol,
where eq % is based on the total hydroxyl equivalents in the reactants.

Reactants used to prepare an isocyanate-functional polyurethane prepolymer provided by the present disclosure can comprise a diisocyanate or a combination of diisocyanates.

Diisocyanate refers to an organic component having two isocyanate groups, —N═C═O. A diisocyanate can include an aliphatic diisocyanate, an alicyclic diisocyanate, and an aromatic diisocyanate. A diisocyanate can have a molecular weight of, for example, less than 1,500 Daltons, less than 1,250 Daltons, less than 1,000 Daltons, less than 750 Daltons, or less than 500 Daltons. A diisocyanate is capable of forming a covalent bond with a reactive group such as hydroxyl, thiol, or amine functional group. A diisocyanate useful in the present invention can be branched or unbranched. Use of branched diisocyanates can be desirable to increase the free volume within the cured polymer matrix to provide space for the molecules to move.

A diisocyanate can comprise an aliphatic diisocyanate, an alicyclic diisocyanate, an aromatic diisocyanate, or a combination of any of the foregoing. A diisocyanate can comprise an aliphatic diisocyanate.

Examples of suitable aliphatic diisocyanates include isophorone diisocyanate (IPDI), tetra-methyl diisocyanate (TMXDI), Desmodur W (H₁₂MDI), and HDI.

Suitable aliphatic diisocyanates for preparing urethane/urea-containing polythiol prepolymers provided by the present disclosure include isophorone diisocyanate (IPDI), tetramethylxylene diisocyanate (TMXDI), 4,4′-methylene dicyclohexyl diisocyanate (H₁₂MDI), methylene diphenyl diisocyanate (MDI), toluene diisocyanate (TDI), 1,6-hexamethylene diisocyanate (HDI), 1,5-diisocyanato-pentane, and a combination of any of the foregoing.

Examples of suitable aliphatic diisocyanates include 1,6-hexamethylene diisocyanate, 1,5-diisocyanato-2-methylpentane, methyl-2,6-diisocyanatohexanoate, bis(isocyanatomethyl)cyclohexane, 1,3-bis(isocyanatomethyl)cyclohexane, 2,2,4-trimethylhexane 1,6-diisocyanate, 2,4,4-trimethylhexane 1,6-diisocyanate, 2,5(6)-bis(isocyanatomethyl)cyclo[2.2.1]heptane, 1,3,3-trimethyl-1-(isocyanatomethyl)-5-isocyanatocyclohexane, 1,8-diisocyanato-2,4-dimethyloctane, octahydro-4,7-methano-1H-indenedimethyl diisocyanate, and 1,1′-methylenebis(4-isocyanatocyclohexane), and 4,4-methylene dicyclohexyl diisocyanate) (H₁₂MDI). Examples of suitable aromatic diisocyanates include 1,3-phenylene diisocyanate, 1,4-phenylene diisocyanate, 2,6-toluene diisocyanate (2,6-TDI), 2,4-toluene diisocyanate (2,4-TDI), a blend of 2,4-TDI and 2,6-TDI, 1,5-diisocyanatonaphthalene, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethane diisocyanate (MDI), 3,3′-dimethyl-4,4′-biphenylene isocyanate, 3,3′-dimethoxy-4,4′-biphenylene diisocyanate, 1-[(2,4-diisocyanatophenyl)methyl]-3-isocyanato-2-methyl benzene, and 2,4,6-triisopropyl-m-phenylene diisocyanate.

Examples of suitable alicyclic diisocyanates include isophorone diisocyanate, cyclohexane diisocyanate, methylcyclohexane diisocyanate, bis(isocyanatomethyl)cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane, and 2-isocyanatomethyl-2-(3-isocyanatopropyl)-6-(2-isocyanatoethyl)-bicyclo[2.2.1]-heptane.

Examples of suitable aromatic diisocyanates in which the isocyanate groups are not bonded directly to the aromatic ring include bis(isocyanatoethyl)benzene, α,α,α′,α′-tetramethylxylene diisocyanate, 1,3-bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl)phthalate, and 2,5-di(isocyanatomethyl)furan. Aromatic diisocyanates having isocyanate groups bonded directly to the aromatic ring include phenylene diisocyanate, ethylphenylene diisocyanate, isopropylphenylene diisocyanate, dimethylphenylene diisocyanate, diethylphenylene diisocyanate, diisopropylphenylene diisocyanate, naphthalene diisocyanate, methylnaphthalene diisocyanate, biphenyl diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate, dichlorocarbazole diisocyanate, 4,4′-diphenylmethane diisocyanate, p-phenylene diisocyanate, 2,4-toluene diisocyanate, and 2,6-toluene diisocyanate.

Other examples of suitable aromatic diisocyanates include 1,3-phenylene diisocyanate, 1,4-phenylene diisocyanate, 2,6-toluene diisocyanate (2,6-TDI), 2,4-toluene diisocyanate (2,4-TDI), a blend of 2,4-TDI and 2,6-TDI, 1,5-diisocyanato naphthalene, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethane diisocyanate (MDI), 3,3′-dimethyl-4,4′-biphenylene isocyanate, 3,3′-dimethoxy-4,4′-biphenylene diisocyanate, 1-[(2,4-diisocyanatophenyl)methyl]-3-isocyanato-2-methyl benzene, 2,4,6-triisopropyl-m-phenylene diisocyanate, 4,4-methylene dicyclohexyl diisocyanate (H₁₂MDI), and a combination of any of the foregoing.

Other examples of suitable diisocyanates for preparing urethane/urea-containing prepolymers include 2,2,4-trimethylhexamethylene diisocyanate (TMDI), 1,6-hexamethylene diisocyanate (HDI), 1,1′-methylene-bis-(4-isocyanatocyclohexane), 4,4′-methylene-bis-(cyclohexyl diisocyanate), hydrogenated toluene diisocyanate, 4,4′-isopropylidene-bis-(cyclohexyl isocyanate), 1,4-cyclohexyl diisocyanate (CHDI), 4,4′-dicyclohexylmethane diisocyanate (Desmodur® W), and 3-isocyanato methyl-3,5,5-trimethylcyclohexyl diisocyanate, and isophorone diisocyanate (IPDI). Mixtures and combinations of these diisocyanates can also be used.

A suitable diisocyanate can have a molecular weight, for example, from 150 Daltons to 600 Daltons, from 100 Daltons to 1,000 Daltons, or from 300 Daltons to 1,000 Daltons.

An aliphatic diisocyanate can have a molecular weight, for example, from 100 Daltons to 400 Daltons, from 125 Daltons to 375 Daltons, from 150 Daltons to 350 Daltons, from 175 Daltons to 325 Daltons, or from 200 Daltons to 300 Daltons.

Reactants can comprise, for example, from 25 wt % to 45 wt %, from 27 wt % to 43 wt %, from 29 wt % to 41 wt %, from 31 wt % to 39 wt %, or from 33 wt % to 37 wt % of a diisocyanate or combination of diisocyanates, where wt % is based on the total weight of the reactants.

Reactants can comprise, for example, from 61 mol % to 81 mol %, from 63 mol % to 79 mol %, from 65 mol % to 77 mol %, or from 67 mol % to 75 mol % of a diisocyanate or combination of diisocyanates, where mol % is based on the total moles of the reactants.

Reactants for preparing an isocyanate-functional polyurethane prepolymer provided by the present disclosure can comprise, for example,
from 20 mol % to 40 mol % of a polyol; and
from 60 mol % to 80 mol % of a diisocyanate,
where mol % is based on the total moles of polyol and diisocyanate of the reactants.

Reactants for preparing an isocyanate-functional polyurethane prepolymer provided by the present disclosure can comprise, for example,
from 25 mol % to 35 mol % of a polyol; and
from 65 mol % to 75 mol % of a diisocyanate,
where mol % is based on the total moles of polyol and diisocyanate of the reactants.

Reactants for preparing an isocyanate-functional polyurethane prepolymer provided by the present disclosure can comprise, for example,
from 55 wt % to 75 wt % of a polyol; and
from 25 wt % to 45 wt % of a diisocyanate,
where wt % is based on the total moles of the polyol and isocyanate in the reactants.

Reactants for preparing an isocyanate-functional polyurethane prepolymer provided by the present disclosure can comprise, for example,
from 60 wt % to 70 wt % of a polyol; and
from 30 wt % to 40 wt % of a diisocyanate,
where wt % is based on the total moles of the polyol and isocyanate in the reactants.

Reactants used to prepare a polyurethane prepolymer provided by the present disclosure can comprise, for example,
from 48 wt % to 68 wt % of a polymeric diol;
from 1 wt % to 6 wt % of a non-linear short chain diol;
from 1 wt % to 6 wt % of a multifunctional polyol; and
from 25 wt % to 45 wt % of a diisocyanate,
where mol % is based on the total moles of the reactants.

Reactants used to prepare a polyurethane prepolymer provided by the present disclosure can comprise, for example,
from 53 wt % to 63 wt % of a polymeric diol;
from 2 wt % to 5 wt % of a non-linear short chain diol;
from 2 wt % to 5 wt % of a multifunctional polyol; and
from 30 wt % to 40 wt % of a diisocyanate,
where mol % is based on the total moles of the reactants.

Reactants used to prepare a polyurethane prepolymer provided by the present disclosure can comprise, for example,
from 6 mol % to 26 mol % of a polymeric diol;
from 6 wt % to 16 mol % of a non-linear short chain diol;
from 1 mol % to 3 mol % of a multifunctional polyol; and
from 61 mol % to 81 mol % of a diisocyanate,
where mol % is based on the total moles of the reactants.

Reactants used to prepare a polyurethane prepolymer provided by the present disclosure can comprise, for example,
from 11 mol % to 21 mol % of a polymeric diol;
from 8 wt % to 14 mol % of a non-linear short chain diol;
from 1 mol % to 3 mol % of a multifunctional polyol; and
from 66 mol % to 76 mol % of a diisocyanate,
where mol % is based on the total moles of the reactants.

Reactants can comprise, for example, an isocyanate to hydroxyl equivalents ratio from 2 to 2.4, or from 2.1 to 2.3, where the isocyanate to hydroxyl equivalents ratio is based on the total isocyanate equivalents and the total hydroxyl equivalents of the reactants.

Reactants can comprise a weight ratio of polyols to diisocyanate is from 0.44 to 0.64, where the weight ratio is based on the total weight of the polyols and the diisocyanate in the reactants.

Reactants can comprise an equivalents ratio of hydroxyl to isocyanate from 0.34 to 0.54, wherein the equivalents ratio is based on the total hydroxyl equivalents and isocyanate equivalents of the reactants.

In an isocyanate-functional polyurethane prepolymer provided by the present disclosure, from 22 mol % to 36 mol % of the segments can be derived from a polyol, and from 64 mol % to 78 mol % of the segments can be derived from a diisocyanate, where mol % is based on the total moles of the polyol-derived segments and diisocyanate-derived segments in the prepolymer.

In an isocyanate-functional polyurethane prepolymer provided by the present disclosure, from 22 mol % to 36 mol %, from 24 mol % to 34 mol %, from 26 mol % to 33 mol %, or from 28 mol % to 31 mol % of the segments can be derived from a polyol, where mol % is based on the total moles of the polyol-derived segments and diisocyanate-derived segments in the prepolymer.

In an isocyanate-functional polyurethane prepolymer provided by the present disclosure, the hard segment content can be, for example, from 64 mol % to 78 mol %, from 66 mol % to 76 mol %, from 68 mol % to 74 mol %, or from 70 mol % to 72 mol % of the segments can be derived from a diisocyanate, where mol % is based on the total moles of the polyol-derived segments and diisocyanate-derived segments in the prepolymer.

In an isocyanate-functional polyurethane prepolymer provided by the present disclosure, from 55 wt % to 75 wt % of the prepolymer can be derived from the polyols, and from 25 wt % to 45 wt % can be derived from the diisocyanates, where wt % is based on the total weight of the isocyanate-functional polyurethane prepolymer.

In an isocyanate-functional polyurethane prepolymer provided by the present disclosure, from 58 wt % to 72 wt % of the prepolymer can be derived from the polyols, and from 28 wt % to 42 wt % can be derived from the diisocyanate, where wt % is based on the total weight of the isocyanate-functional polyurethane prepolymer.

In an isocyanate-functional polyurethane prepolymer provided by the present disclosure, from 61 wt % to 69 wt % of the prepolymer can be derived from the polyols, and from 31 wt % to 39 wt % can be derived from the diisocyanate, where wt % is based on the total weight of the isocyanate-functional polyurethane prepolymer.

In an isocyanate-functional polyurethane prepolymer provided by the present disclosure, from 50 wt % to 70 wt % of the prepolymer can be derived from a polymeric diol, from 1 wt % to 5 wt % can be derived from a non-linear short chain diol, from 1 wt % to 5 wt % can be derived from a multifunctional polyol, and from 25 wt % to 45 wt % of the prepolymer can be derived from a diisocyanate, where wt % is based on the total weight of the isocyanate-functional polyurethane prepolymer.

In an isocyanate-functional polyurethane prepolymer provided by the present disclosure, from 55 wt % to 65 wt % of the prepolymer can be derived from a polymeric diol, from 2 wt % to 4 wt % can be derived from a non-linear short chain diol, from 2 wt % to 4 wt % can be derived from a multifunctional polyol, and from 30 wt % to 40 wt % of the prepolymer can be derived from a diisocyanate, where wt % is based on the total weight of the isocyanate-functional polyurethane prepolymer.

In an isocyanate-functional polyurethane prepolymer provided by the present disclosure, the segments derived from a polyol can comprise, for example:
from 49% to 63% of the segments can be derived from a polymeric diol;
from 31% to 45% of the segments can be derived from a non-linear short chain diol; and
from 3% to 9% of the segments can be derived from a multifunctional polyol; where percent is based on the total number of segments derived from a polyol in the prepolymer.

In an isocyanate-functional polyurethane prepolymer provided by the present disclosure, the segments derived from a polyol can comprise, for example:
from 51% to 61% of the segments can be derived from a polymeric diol;
from 33% to 43% of the segments can be derived from a non-linear short chain diol; and
from 4% to 8% of the segments can be derived from a multifunctional polyol;
where percent is based on the total moles of the segments derived from a polyol in the prepolymer.

In an isocyanate-functional polyurethane prepolymer provided by the present disclosure, the segments derived from a polyol can comprise, for example:
from 53% to 59% of the segments can be derived from a polymeric diol;
from 35% to 41% of the segments can be derived from a non-linear short chain diol; and
from 4% to 8% of the segments can be derived from a multifunctional polyol;
where percent is based on the total moles of the segments derived from a polyol in the prepolymer.

In an isocyanate-functional polyurethane prepolymer provided by the present disclosure, the segments derived from a polyol can comprise, for example:
from 55% to 57% of the segments can be derived from a long polymeric diol;
from 37% to 39% of the segments can be derived from a non-linear short chain diol; and
from 5% to 7% of the segments can be derived from a multifunctional polyol;
where percent is based on the total moles of the segments derived from a polyol in the prepolymer.

In an isocyanate-functional polyurethane prepolymer provided by the present disclosure,
from 86 wt % to 94 wt % of the polyol segments can be derived from a polymeric diol;
from 3 wt % to 7 wt % of the polyol segments can be derived from a non-linear short chain diol; and
from 3 wt % to 7 wt % of the polyol segments can be derived from a multifunctional polyol;
where wt % is based on the total weight of the segments derived from a polyol in the prepolymer.

In an isocyanate-functional polyurethane prepolymer provided by the present disclosure,
from 88 wt % to 92 wt % of the polyol segments can be derived from the polymeric diol;
from 4 wt % to 6 wt % of the polyol segments can be derived from the non-linear short chain diol; and
from 4 wt % to 6 wt % of the polyol segments can be derived from the multifunctional polyol;
where wt % is based on the total weight of the segments derived from a polyol in the prepolymer.

An isocyanate-functional polyurethane prepolymer provided by the present disclosure can be characterized by a hard segment content and a soft segment content.

The hard segment content of a polyurethane prepolymer includes the segments derived from linear short chain diols and segments derived from diisocyanates.

The soft segment content of a polyurethane prepolymer includes the segments derived from polymeric diols and non-linear short chain diols.

In an isocyanate-functional polyurethane prepolymer provided by the present disclosure, the soft segment content can be, for example, from 20% to 35% and the hard segment content can be, for example, from 65% to 80%, where percent is based on the total number soft segments and the hard segments.

In an isocyanate-functional polyurethane prepolymer provided by the present disclosure, the soft segment content can be, for example, from 22% to 33%, from 24% to 31%, or from 26% to 29%, where percent is based on the total number of the soft segments and the hard segments.

In an isocyanate-functional polyurethane prepolymer provided by the present disclosure, the hard segment content can be, for example, from 22% to 33%, from 24% to 31%, or from 26% to 29%, where percent is based on the total number of the soft segments and the hard segments.

An isocyanate-terminated polyurethane prepolymer provided by the present disclosure can comprise a hard segment content, for example, from 25 wt % to 45 wt % and a soft segment content from 55 wt % to 75 wt %, where wt % is based on the total weight of the isocyanate-functional polyurethane prepolymer.

An isocyanate-terminated polyurethane prepolymer provided by the present disclosure can comprise a hard segment content, for example, from 30 wt % to 40 wt % and a soft segment content from 60 wt % to 70 wt %, where wt % is based on the total weight of the isocyanate-functional polyurethane prepolymer.

An isocyanate-functional polyurethane prepolymer provided by the present disclosure can have the structure of Formula (5) or Formula (5a):

—P^{a}—(I^{a}—P^{a}-)ₙ- (5)

I^{b}—P^{a}—(I^{a}—P^{a}-)ₙ-I^{b} (5a)
wherein,
   n is an integer from 1 to 50;
   each I^{a} and I^{b} is independently a moiety derived from a diisocyanate I;
   each P^{a} is independently selected from a moiety derived from a polymeric diol, a moiety derived from a non-linear short chain diol, and a moiety derived from a multifunctional polyol; wherein,
      from 46% to 66% of the moieties P^{a} are derived from the polymeric diol,
      from 4.8% to 6.8% of the moieties P^{a} are derived from the multifunctional polyol,
      from 28% to 38% of the moieties P^{a} are derived from the non-linear short chain diol, and
      percent is based on the total number of moieties P^{a}.

A diisocyanate I can have the structure of Formula (6):

O═C═N—R¹—N═C═O (6)

where R¹ is selected from selected from C₂₋₁₀ alkanediyl, C₂₋₁₀, heteroalkanediyl, C₅₋₁₂ cycloalkanediyl, C₅₋₁₂ heterocycloalkanediyl, C₆₋₂₀ arenediyl, C₅₋₂₀ heteroarenediyl, C₆₋₂₀ alkanecycloalkanediyl, C₆₋₂₀ heteroalkanecycloalkanediyl, C₇₋₂₀ alkanearenediyl, C₇₋₂₀ heteroalkanearenediyl, substituted C₂₋₁₀ alkanediyl, substituted C₂₋₁₀, heteroalkanediyl, substituted C₅₋₁₂ cycloalkanediyl, substituted C₅₋₁₂ heterocycloalkanediyl, substituted C₆₋₂₀ arenediyl, substituted C₅₋₂₀ heteroarenediyl, substituted C₆₋₂₀ alkanecycloalkanediyl, substituted C₆₋₂₀ heteroalkanecycloalkanediyl, substituted C₇₋₂₀ alkanearenediyl, and substituted C₇₋₂₀ heteroalkanearenediyl.

A moiety I^{a} derived from a diisocyanate I can have the structure of Formula (6a):

—C(═O)—NH—R¹—NH—C(═O)— (6a)

where R¹ is defined as for Formula (6).

A moiety I^{b} derived from a diisocyanate I can have the structure of Formula (6b):

—C(═O)—NH—R¹—NH—N═C═O (6b)

where R¹ is defined as for Formula (6).

A nonlinear short chain diol can have the structure of Formula (1):

HO—R²—OH (1)

where R² can be selected from —(C(R⁵)₂)ₛ— where s can be an integer from 1 to 10; each R⁵ can independently be selected from hydrogen and C₁₋₆ alkyl, and at least one R⁵ can be C₁₋₆ alkyl.

A moiety P^{a} derived from a nonlinear short chain diol can have the structure of Formula (1a):

—O—R²(—OH)_{z-2}—O— (1a)

where R² is defined as for Formula (1) and z in an integer from 3 to 6.

A multifunctional polyol can have the structure of Formula (3):

B(—OH)_{z} (3)

where z is an integer from 3 to 6; and B is a core of a multifunctional polyol.

For example, B can be selected from C₅₋₁₀ cycloalkanediyl, C₆₋₁₈ alkanecycloalkanediyl, C₅₋₁₀ heterocycloalkanediyl, C₆₋₁₈ heteroalkanecycloalkanediyl, substituted C₅₋₁₀ cycloalkanediyl, substituted C₆₋₁₈ alkanecycloalkanediyl, substituted C₅₋₁₀ heterocycloalkanediyl, and substituted C₆₋₁₈ heteroalkanecycloalkanediyl.

A moiety P^{a} derived from a multifunctional polyol can have the structure of Formula (3a):

—O—B(—O—)_{z-2}—O— (3a)

where m and B are defined as in Formula (3), z is an integer from 3 to 6, and each ether group (—O—) is bonded to a moiety derived from a diisocyanate.

An isocyanate-functional polyurethane prepolymer of Formula (5) and (5a) can comprise, for example, from 60% to 80% of moieties P^{a} and I^{b} and from 20% to 40% of moieties P^{a}, where % is based on the total number of moieties I^{a}, I^{b}, and P^{a}.

An isocyanate-functional polyurethane prepolymer of Formula (5) and (5a) can comprise, for example, from 65% to 75% of moieties I^{a} and I^{b} and from 25% to 35% of moieties P^{a}, where % is based on the total number of moieties I^{a}, I^{b}, and P^{a}.

In an isocyanate-functional polyurethane prepolymer of Formula (5) and (5a), the polymeric diol can comprise a polymeric polycarbonate diol and the moiety P^{a} can be derived from a polymeric polycarbonate diol.

In an isocyanate-functional polyurethane prepolymer of Formula (5) and (5a), the multifunctional polyol can comprise a trifunctional polyol, a tetrafunctional polyol, or a combination thereof. In an isocyanate-functional polyurethane prepolymer of Formula (5) and (5a), the multifunctional polyol can comprise a trifunctional and/or tetrafunctional polycaprolactone polyol.

In a polyurethane prepolymer of Formula (5) and (5a), the non-linear short chain diol can comprise 4-dimethyl-1,5-pentane diol.

In a polyurethane prepolymer of Formula (5) and (5a), the diisocyanate can comprise 4,4′-diisocyanatodicyclohexylmethane.

In an isocyanate-functional polyurethane prepolymer of Formula (5) and (5a),
from 42 eq % to 62 eq % of the P^{a} moieties can be derived from the polymeric diol;
from 9 eq % to 13 eq % of the P^{a} moieties can be derived from the multifunctional polyol; and
from 26 eq % to 46 eq % of the P^{a} moieties can be derived from the non-linear short chain diol;
where mol % is based on the total hydroxyl equivalents of the polyol P.

An isocyanate-functional polyurethane prepolymer provided by the present disclosure can have the structure of Formula (7):

O═C═N—R¹—NH—C(O)—O—R⁴(-E)ₐ-O(—C(═O)—NH—R¹—NH—C(═O)—O—R²(-E)ₐ-O)ₚ—C(═O)—NH—R¹—N═C═O (7)

wherein,
each m can independently be an integer from 2 to 6;
each E can independently have the structure of Formula (8):

—O—{—C(═O)—NH—R¹—NH—C(═O)—O—R²—O}ₙ—C(═O)—NH—R¹—N═C═O (8)
wherein,
   p is an integer from 1 to 50;
   each q is independently an integer from 0 to 4;
   each R¹ is independently defined as for Formula (6);
   each R⁴ is independently selected from:
      a core of a polymeric diol and q is 0;
      a moiety R² of a non-linear short chain diol is defined as for Formula (1) and q is 0; and
      a moiety B of a multifunctional diol as defined as for Formula (3) and q is an integer from 1 to 4;
      from 46% to 66% of the polyol segments are derived from the polymeric diol;
      from 4.8% to 6.8% of the segments are derived from the non-linear short chain diol; and
      from 28% to 48% of the segments are derived from the multifunctional polyol,
      where % is based on the number of segments derived from a polyol.

In an isocyanate-functional polyurethane prepolymer provided by the present disclosure, the hard segment content can be, for example, from 67% to 78%, 69% to 76%, or from 71% to 74%, where percent is based on the total number of the soft and hard segments.

An isocyanate-functional polyurethane prepolymer provided by the present disclosure can have a number average molecular weight, for example, within a range from 4,000 Daltons to 24,000 Daltons, from 4,000 Daltons to 20,000 Daltons, from 4,000 to 15,000 Daltons, from 4,000 Daltons to 10,000 Daltons, or from 5,000 Daltons to 9,000 Daltons, where the number average molecular weight is determined using gel permeation chromatography and a polystyrene standard.

An isocyanate-functional polyurethane prepolymer provided by the present disclosure can have an isocyanate value, for example, from 4 to 7, such as from 4.5 to 6.5, or from 5.0 to 6.0, where the isocyanate value is determined based on back titration with excess amines.

An isocyanate-functional polyurethane prepolymer provided by the present disclosure can have a viscosity, for example, within a range from 15,000 cps to 65,000 cps (15,000 mPa-s to 65,000 mPa-s), from 20,000 cps to 60,000 cps (20,000 mPa-s to 60,000 mPa-s), or from 25,000 cps to 55,000 cps (25,000 mPa-s to 55,000 mPa-s), where the viscosity is measured using a Brookfield CAP 2000 viscometer, spindle #2, at 25° C., and 1 rpm.

An isocyanate-functional polyurethane prepolymer provided by the present disclosure can be synthesized by combining a polymeric diol, a non-linear short chain diol, a multifunctional polyol, and a diisocyanate with a suitable solvent and reacting at elevated temperature such as at a temperature from 50° C. to 80° C. for from 1 hours to 3 hours.

A coating composition provided by the present disclosure can comprise an isocyanate-functional polyurethane prepolymer provided by the present disclosure and a polyamine curing agent.

A coating composition provided by the present disclosure can comprise a polyamine or a combination of polyamines.

A polyamine can have an average amine functionality, for example, from 2 to 6, from 2 to 5, from 2 to 4, or from 2 to 3. A polyamine can have an amine functionality of 2, 3, 4, 5, 6, or a combination of any of the foregoing.

A polyamine can comprise an aliphatic polyamine, a cycloaliphatic polyamine, an aromatic polyamine, or a combination of any of the foregoing. A polyamine curing agent can have at least two amine groups selected from a primary amine group (—NH₂), a secondary amine group (—NH—), and combinations thereof. A polyamine curing agent can have at least two primary amine groups.

Examples of suitable polyamines include ethylenediamine (EDA); diethylenetriamine (DETA); triethylenetetramine (TETA); tetraethylenepentamine (TEPA); N-amino ethylpiperazine (N-AEP); isophorone diamine (1PDA); 1,3-cyclohexanebis(methylamine) (1,3-BAC); 4,4′-methylenebis(cyclohexylamine) (PACM); m-xylylenediamine (MXDA); or mixtures thereof.

A polyamine can comprise an aliphatic polyamine such as ethylenediamine (EDA), diethylenetriamine (DETA), triethylenetetramine (TETA, tetraethylenepentamine (TEPA), dipropylenediamine, diethylaminopropylamine, polypropylenetriamine, pentaethylenehexamine (PEHA), and N-aminoethylpiperazine (N-AEP).

A polyamine can comprise a monomeric polyamine, a polyamine prepolymer, or a combination thereof.

A polyamine can comprise an amine blend/modified amine including a cycloaliphatic amine.

The amine in this application is a cycloaliphatic amine or any amine blend/modified amine including cycloaliphatic amine.

A polyamine can comprise a cycloaliphatic polyamine.

Examples of suitable cycloaliphatic polyamines include cycloaliphatic polyamine such as menthendiamine, isophoronediamine, bis(4-amino-3-methyldicyclohexyl)methane, diaminodicyclohexylmethane, bis(aminomethyl)cyclohexane, N-aminoethylpiperazine, and 3,9-bis(3-aminopropyl)-3,4,8,10-tetraoxaspiro[5,5]undecane, isophorone diamine (IPDA), 1,3-cyclohexanebis(methylamine) (1,3-BAC); and 4,4′-methylenebis(cyclohexylamine) (PACM; bis-(p-aminocyclohexyl)methane).

A cycloaliphatic polyamine can comprise 4,4′-methylenebis(cyclohexylamine).

Examples of suitable secondary amines include, for example, cycloaliphatic diamines such as Jefflink® 754 (N-isopropyl-3-((isopropylamino)methyl)3,5,5-trimethylcyclohexan-1-amine) and aliphatic diamines such as Clearlink® 1000 (4,4′-methylenebis(N-secbutylcyclohexanamine)).

A polyamine can comprise an aromatic polyamine. Examples of suitable aromatic polyamines include m-phenylenediamine, p-phenylenediamine, tolylene-2,4-diamine, tolylene-2,6-diamine, mesitylene-2,4-diamine, 3,5-diethyltolylene-2,4-diamine, a 3,5-diethyltolylene-2,6-diamine, biphenylenediamine, 4,4-diaminodiphenylmethane, 2,5-naphthylenediamine, and 2,6-naphthylenediamine, tris(aminophenyl)methane, bis(aminomethyl)norbornane, piperazine, ethylenediamine, diethylenetriamine, triethylenetetramine, tetraethylenepentamine, 1-(2-aminoethyl)piperazine, bis(aminopropyl)ether, bis(aminopropyl)sulfide, isophorone diamine, 1,2-diaminobenzene; 1,3-diaminobenzene; 1,4-diaminobenzene; 4,4′-diaminodiphenylmethane; 4,4′-diaminodiphenylsulfone; 2,2′-diaminodiphenylsulfone; 4,4′-diaminodiphenyl oxide; 3,3′,5,5′-tetramethyl-4,4′-diaminodiphenyl; 3,3′-dimethyl-4,4′-diaminodiphenyl; 4,4′-diamino-α-methylstilbene; 4,4′-diaminobenzanilide; 4,4′-diaminostilbene; 1,4-bis(4-aminophenyl)-trans-cyclohexane; 1,1-bis(4-aminophenyl)cyclohexane; 1,2-cyclohexanediamine; 1,4-bis(aminocyclohexyl)methane; 1,3-bis(aminomethyl)cyclohexane; 1,4-bis(aminomethyl)cyclohexane; 1,4-cyclohexanediamine; 1,6-hexanediamine, 1,3-xylenediamine; 2,2′-bis(4-aminocyclohexyl)propane; 4-(2-aminopropan-2-yl)-1-methylcyclohexan-1-amine(methane diamine); and combinations of any of the foregoing.

A polyamine can comprise a polyamine prepolymer or combination of polyamine prepolymers.

A polyamine prepolymer can have any of the prepolymer backbones as disclosed herein such as any of the prepolymer backbones described for polythiol prepolymer.

A polyamine prepolymer can comprise an amine-functional sulfur-containing prepolymer such as an amine-functional polythioether prepolymer, an amine-functional polysulfide prepolymer, an amine-functional sulfur-containing polyformal prepolymer, an amine-functional monosulfide prepolymer, or a combination of any of the foregoing.

Examples suitable polymeric polyamines include polyoxyalkylene amines such as Jeffamine® D-230 and Jeffamine® D-400 commercially available from Huntsman Corporation.

Other examples of suitable polymeric polyamines include polyetheramines such as polypropylene glycol diamines (Jeffamine® D), polyethylene glycol diamines (Jeffamine® ED), Jeffamine® EDR diamines, polytetramethylether glycol/polypropylene glycol copolymer diamines or triamines (Jeffamine® THG), polypropylene triamines (Jeffamine® T), and cycloaliphatic polyetheramines (Jeffamine® RFD-270).

A polyamine can comprise a diamine such as, for example, 3,5-diethyltoluene-2,4-diamine, 3,5-diethyltoluene-2,6-diamine, or combination thereof. A polyamine can comprise an Ethacure® polyamine such as Ethacure® 100, Ethacure® 300, Ethacure® E520, and Etahcure® E534 available from Albemarle.

A polyamine can be a blocked polyamine. A blocked polyamine can react with water such as atmospheric moisture to expose reactive amine groups. A blocked polyamine can be unblocked by exposure to moisture during spray coating.

A polyamine curing agent can be a blocked, moisture-activated polyamine curing agent such as, for example, Vestamin® A-139. Examples of suitable blocked, moisture-activated polyamine curing agents include ketimines, enamines, oxazolidines, aldimines, and imidazolidines. In the presence of moisture, the blocking group, e.g., the ketamine, enamine, oxazolidine, aldimine, or imidazolidine blocking group or groups reacts with water to provide a catalytic amine catalyst and a ketone or alcohol. Suitable blocked reactive polyamines are disclosed, for example, in U.S. Pat. No. 5,206,200.

A coating composition provided by the present disclosure can comprise a combination of a blocked polyamine and an un-blocked polyamine. Examples of suitable unblocked polyamines include Vestamine® TMD and isophorone diamine.

Examples of suitable polyfunctional polyamines include 1,3,5-triazine-2,4,6-triamine, benzene-1,3,5-triamine, pyrimidine-4,5,6-triamine, 4H-1,2,4-triazole-3,4,5-triamine, benzene-1,2,4-triamine, and 2,6-dimethylbenzene-1,3,5-triamine.

A coating composition can comprise, for example, from 70 mol % to 100 mol %, from 80 mol % to 100 mol %, or from 90 mol % to 100 mol % of an unblocked polyamine, where mol % is based on the total moles of the polyamine curing agent, and the remainder of the polyamine curing agent comprises a blocked polyamine. A coating composition can comprise greater than 70 mol %, greater than 80 mol % or greater than 90 mol % of an unblocked polyamine, where mol % is based on the total moles of the polyamine curing agent, and the remainder of the polyamine curing agent comprises a blocked polyamine.

A coating composition can comprise, for example, from 70 wt % to 100 wt %, from 80 wt % to 100 wt %, or from 90 wt % to 100 wt % of an unblocked polyamine, where wt % is based on the total weight of the polyamine curing agent, and the remainder of the polyamine curing agent comprises a blocked polyamine. A coating composition can comprise greater than 70 wt %, greater than 80 wt % or greater than 90 wt % of an unblocked polyamine, where wt % is based on the total weight of the polyamine curing agent, and the remainder of the polyamine curing agent comprises a blocked polyamine.

A coating composition provided by the present disclosure can comprise, for example, from 1 wt % to 15 wt % of a polyamine or combination of polyamines, from 1 wt % to 12 wt %, from 1 wt % to 10 wt %, from 1 wt % to 8 wt %, or from 2 wt % to 6 wt % of a polyamine or combination of polyamines, where wt % is based on the total solids weight of the composition.

The equivalent ratio of isocyanate groups to amine in a coating composition can be, for example, from 1.0 to 0.6 from 1.0 to 0.7 from 1.0 to 0.8, from 1.0 to 0.9. A coating composition can have, for example, a 10 mol % excess of isocyanate groups to amine groups, an excess of 15 mol %, an excess of 20 mol %, and excess of 25 mol %, an excess of 30 mol %, an excess of 40 mol %, or an excess of 50 mol % isocyanate groups to amine groups.

A coating composition provided by the present disclosure can have an equivalent ratio of isocyanate groups to amine groups, for example, from 1.0 to 0.6, from 1.0 to 0.7, from 1.0 to 0.8, or from 1.0 to 0.9. A coating composition provided by the present disclosure can have an equivalent ratio of isocyanate groups to amine groups, for example, less than or equal to 1.0, less than 0.9, less than 0.8, or less than 0.7. A coating composition provided by the present disclosure can have an equivalent ratio of isocyanate groups to amine groups, for example, equal to or greater than 0.6, greater than 0.7, greater than 0.8, or greater than 0.9.

A coating composition provided by the present disclosure can be a sprayable coating composition.

A sprayable coating composition provided by the present disclosure can comprise a solvent or combination of solvents.

Examples of suitable solvents include acetone, methylethyl ketone (MEK), methyl n-amyl ketone (MAK), methyl isoamyl ketone, diisobutyl ketone, methyl isobutyl ketone, methyl isopropyl ketone, methyl propyl ketone, and combinations of any of the foregoing.

A sprayable composition can contain, for example, from 15 wt % to 40 wt % solvent or combination of solvents, from 20 wt % to 35 wt %, or from 25 wt % to 30 wt % solvent or combination of solvents, where wt % is based on the total weight of the sprayable composition.

A sprayable coating composition can comprise, for example, a solids content from 60 wt % to 75 wt %, where wt % is based on the total weight of the solids in the sprayable coating composition.

Coating compositions provided by the present disclosure can include one or more additives such as, for example, catalysts, polymerization initiators, adhesion promoters, reactive diluents, plasticizers, filler, colorants, photochromic agents, rheology modifiers, cure activators and accelerators, corrosion inhibitors, fire retardants, UV stabilizers, thermal stabilizers, rain erosion inhibitors, or a combination of any of the foregoing.

Coating compositions provided by the present disclosure can comprise a filler or a combination of filler. A filler can comprise, for example, an inorganic filler, an organic filler, a low-density filler, an electrically conductive filler, or a combination of any of the foregoing. A filler can comprise an organic filler, an inorganic filler, an electrically conductive filler, a low-density filler, or a combination of any of the foregoing.

Filler can be added to a coating composition, for example, to improve the physical properties of a cured coating, to reduce the weight of a cured coating, and/or to impart electrical conductivity to the coating.

Compositions and sealants provided by the present disclosure can comprise an organic filler or a combination of organic fillers. Organic fillers can be selected to have a low specific gravity and to be resistant to aviation solvents and/or fluids such as JRF Type I and Skydrol®, such as Skydrol® LD-4.

An organic filler can be selected to be resistant to Skydrol®. For example, an organic filler that is resistant to Skydrol®, such as Skydrol® LD-4, will exhibit a swelling of less than 1 vol % following immersion in Skydrol® at a temperature of less than 50° C. for 1,000 hours, or less than 1.2 vol % following immersion in Skydrol® at a temperature of less than 70° C. for 1,000 hours, where the percent swelling is determined according to EN ISO 10563. Suitable organic fillers can also have acceptable adhesion to the sulfur-containing polymer matrix. An organic filler can include solid particles, hollow particles, or a combination thereof. The particles can be generally spherical (referred to as powders), generally non-spherical (referred to as particulates), or a combination thereof. The particles can have a mean particle diameter less than, for example, 100 μm, 50 μm, 40 μm, 30 μm, or less than 25 μm, as determined according to ASTM E-2651-13. A powder can comprise particles having a mean particle diameter with a range from 0.25 μm to 100 μm, 0.5 μm to 50 μm, from 0.5 μm to 40 μm, from 0.5 μm to 30 μm, from 0.5 μm to 20 μm, or from 0.1 μm to 10 μm. Filler particles can comprise nano-powders, comprising particles characterized by a mean particle size, for example, from 1 nm to 100 nm.

An organic filler can have a specific gravity, for example, less than 1.6, less than 1.4, less than 1.15, less than 1.1, less than 1.05, less than 1, less than 0.95, less than 0.9, less than 0.8, or less than 0.7, where specific gravity is determined according to ISO 787 (Part 10). Organic fillers can have a specific gravity, for example, within a range from 0.85 to 1.6, within a range from 0.85 to 1.4, within a range from 0.85 to 1.1, within a range from 0.9 to 1.05, or from 0.9 to 1.05, where specific gravity is determined according to ISO 787 (Part 10).

Organic fillers can comprise thermoplastics, thermosets, or a combination thereof. Examples of suitable organic fillers include epoxies, epoxy-amides, ETFE copolymers, polyethylenes, polypropylenes, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polyether sulfones, thermoplastic copolyesters, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing.

Examples of suitable organic fillers include polyamides such as polyamide 6 and polyamide 12, polyimides, polyethylene, polyphenylene sulfides, polyether sulfones, thermoplastic copolyesters, and combinations of any of the foregoing.

Examples of suitable polyamide 6 and polyamide 12 particles are available from Toray Plastics as grades SP-500, SP-10, TR-1, and TR-2. Suitable polyamides are also available from the Arkema Group under the tradename Orgasol®, and from Evonik Industries under the tradename Vestosin®. For example, Ganzpearl® polyamides such as Ganzpearl® GPA-550 and GPA-700 are available from Persperse Sakai Trading, New York, NY.

Examples of suitable polyimide fillers are available from Evonik Industries under the tradename P84®NT.

An organic filler can include a polyethylene, such as an oxidized polyethylene powder. Suitable polyethylenes are available, for example, from Honeywell International, Inc. under the tradename ACumist®, from INEOS under the tradename Eltrex®, and Mitsui Chemicals America, Inc. under the tradename Mipelon™.

The use of organic fillers such as polyphenylene sulfide in aerospace sealants is disclosed in U.S. Pat. No. 9,422,451, which is incorporated by reference in its entirety. Polyphenylene sulfide is a thermoplastic engineering resin that exhibits dimensional stability, chemical resistance, and resistance to corrosive and high temperature environments. Polyphenylene sulfide engineering resins are commercially available, for example, under the tradenames Ryton® (Chevron), Techtron® (Quadrant), Fortron® (Celanese), and Torelina® (Toray). Polyphenylene sulfide resins are generally characterized by a specific gravity from about 1.3 to about 1.4, where specific gravity is determined according to ISO 787 (Part 10). Polyphenylene sulfide particles having a density of 1.34 g/cm³ and a mean particle diameter of 0.2 μm to 0.25 μm (in water, or from 0.4 μm to 0.5 μm in isopropanol) are available from Toray Industries, Inc.

Polyether sulfone particles are available from Toray Industries, Inc., which have a density of 1.37 g/cm³ and a mean particle diameter from 5 μm to 60 μm.

Thermoplastic copolyester particles can be obtained from Toray Industries, Inc.

An organic filler can have any suitable shape. For example, an organic filler can comprise fractions of crushed polymer that has been filtered to a desired size range. An organic filler can comprise substantially spherical particles. Particles can be non-porous or can be porous. A porous particle can have a network of open channels that define internal surfaces.

An organic filler can have a mean or median particle size, for example, within a range from 1 μm to 100 μm, 2 μm to 40 μm, from 2 μm to 30 μm, from 4 μm to 25 μm, from 4 μm to 20 μm, from 2 μm to 15 μm, or from 5 μm to 12 μm. An organic filler can have an average particle size, for example, less than 100 μm, less than 75 μm, less than 50 μm, less than 40 μm, or less than 20 μm. Particle size distribution can be determined using a Fischer Sub-Sieve Sizer or by optical inspection.

Compositions and sealants provided by the present disclosure can comprise, for example, from 10 wt % to 35 wt % of an organic filler, from 15 wt % to 35 wt %, from 10 wt % to 30 wt %, from 15 wt % to 30 wt %, from 18 wt % to 32 wt %, from 15 wt % to 25 wt %, from 17 wt % to 23 wt %, from 20 wt % to 30 wt %, or from 22 wt % to 28 wt % of an organic filler, where wt % is based on the total weight of the composition. Compositions and sealants can comprise an organic filler comprising a polyamide, an oxidized polyethylene, aminoplast-coated microcapsules, or a combination of any of the foregoing. Compositions and sealants can comprise an organic filler comprising a polyamide, aminoplast-coated microcapsules, or a combination thereof.

An organic filler can include a low-density filler such as an expanded thermoplastic microcapsule and/or a modified expanded thermoplastic microcapsule. Suitable modified expanded thermoplastic microcapsules can include an exterior coating of a melamine or urea/formaldehyde resin.

A thermally expandable microcapsule refers to a hollow shell comprising a volatile material that expands at a predetermined temperature. Thermally expandable thermoplastic microcapsules can have an average initial particle size of 5 μm to 70 μm, in some cases 10 μm to 24 μm, or from 10 μm to 17 μm. The term “average initial particle size” refers to the average particle size (numerical weighted average of the particle size distribution) of the microcapsules prior to any expansion. The particle size distribution can be determined using a Fischer Sub-Sieve Sizer.

A thermally expandable thermoplastic microcapsule can comprise a volatile hydrocarbon or volatile halogenated hydrocarbon within a wall of a thermoplastic resin. Examples of hydrocarbons suitable for use in such microcapsules are include methyl chloride, methyl bromide, trichloroethane, dichloroethane, n-butane, n-heptane, n-propane, n-hexane, n-pentane, isobutane, isopentane, iso-octane, neopentane, petroleum ether, and aliphatic hydrocarbons containing fluorine, such as Freon™, and combinations of any of the foregoing.

Examples of materials suitable for forming the wall of a thermally expandable microcapsule include polymers of vinylidene chloride, acrylonitrile, styrene, polycarbonate, methyl methacrylate, ethyl acrylate, and vinyl acetate, copolymers of these monomers, and combinations of the polymers and copolymers. A crosslinking agent may be included with the materials forming the wall of a thermally expandable microcapsule.

Examples of suitable thermoplastic microcapsules include Expancel™ microcapsules such as Expancel™ DE microspheres available from AkzoNobel. Examples of suitable Expancel™ DE microspheres include Expancel™ 920 DE 40 and Expancel™ 920 DE 80. Suitable low-density microcapsules are also available from Kureha Corporation.

Low-density microcapsules can be characterized by a specific gravity within a range, for example, from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ISO 787 (Part 10). Low density microcapsules can be characterized by a specific gravity, for example, less than 0.1, less than 0.09, less than 0.08, less than 0.07, less than 0.06, less than 0.05, less than 0.04, less than 0.03, or less than 0.02, wherein the specific gravity is determined according to ISO 787 (Part 10).

Low-density microcapsules can be characterized by a mean particle diameter from 1 μm to 100 μm and can have a substantially spherical shape. Low density microcapsules can be characterized, for example, by a mean particle diameter from 10 μm to 100 μm, from 10 μm to 60 μm, from 10 μm to 40 μm, or from 10 μm to 30 μm, as determined according to ASTM E-2651-13.

Low-density filler can comprise uncoated microcapsules, coated microcapsules, or combinations thereof.

Low-density filler such as low-density microcapsules can comprise expanded microcapsules having a coating of an aminoplast resin such as a melamine resin. Aminoplast resin-coated particles are described, for example, in U.S. Pat. No. 8,993,691, which is incorporated by reference in its entirety. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the particle.

Low density filler such as low-density microcapsules can comprise thermally expandable thermoplastic microcapsules having an exterior coating of an aminoplast resin, such as a melamine resin. The coated low-density microcapsules can have an exterior coating of a melamine resin, where the coating can have a thickness, for example, less than 2 μm, less than 1 μm, or less than 0.5 μm. The melamine coating on the light-weight microcapsules is believed to render the microcapsules reactive with the thiol-terminated polythioether prepolymer and/or the curing agent, which enhances the fuel resistance, and renders the microcapsules resistant to pressure.

The thin coating of an aminoplast resin can have a film thickness of less than 25 μm, less than 20 μm, less than 15 μm, or less than 5 μm. The thin coating of an aminoplast resin can have a film thickness of at least 0.1 nm, such as at least 10 nm, or at least 100 nm, or, in some cases, at least 500 nm.

Aminoplast resins can be based on the condensation products of formaldehyde, with an amino- or amido-group carrying substance. Condensation products can be obtained from the reaction of alcohols and formaldehyde with melamine, urea or benzoguanamine. Condensation products of other amines and amides can also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Examples of such compounds include N,N′-dimethyl urea, benzourea, dicyandiamide, formaguanamine, acetoguanamine, glycoluril, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine and 3,4,6-tris(ethylamino)-1,3,5 triazine. Suitable aminoplast resins can also be based on the condensation products of other aldehydes such as acetaldehyde, crotonaldehyde, acrolein, benzaldehyde, furfural, and glyoxal.

An aminoplast resin can comprise a highly alkylated, low-imino aminoplast resin which has a degree of polymerization less than 3.75, such as less than 3.0, or less than 2.0. The number average degree of polymerization can be defined as the average number of structural units per polymer chain. For example, a degree of polymerization of 1.0 indicates a completely monomeric triazine structure, while a degree of polymerization of 2.0 indicates two triazine rings joined by a methylene or methylene-oxy bridge. Degree of polymerization represents an average degree of polymerization value as determined by gel permeation chromatography using polystyrene standards.

An aminoplast resin can contain methylol or other alkylol groups, and at least a portion of the alkylol groups can be etherified by reaction with an alcohol. Examples of suitable monohydric alcohols include alcohols such as methanol, ethanol, propanol, butanol, pentanol, hexanol, heptanol, benzyl alcohol, other aromatic alcohols, cyclic alcohols such as cyclohexanol, monoethers of glycols, and halogen-substituted or other substituted alcohols, such as 3-chloropropanol and butoxyethanol. Aminoplast resins can be substantially alkylated with methanol or butanol.

An aminoplast resin can comprise a melamine resin. Examples of suitable melamine resins include methylated melamine resins (hexamethoxymethylmelamine), mixed ether melamine resins, butylated melamine resins, urea resins, butylated urea resins, benzoguanamine and glycoluril resins, and formaldehyde free resins. Such resins are available, for example, from Allnex Group and Hexion. Examples of suitable melamine resins include methylated melamine resins such as Cymel™ 300, Cymel™ 301, Cymel™ 303LF, Cymel™ 303ULF, Cymel™ 304, Cymel™ 350, Cymel™ 3745, Cymel™ XW-3106, Cymel™ MM-100, Cymel™ 370, Cymel™ 373, Cymel™ 380, ASTRO MEL™601, ASTRO MEL™ 601ULF, ASTRO MEL™400, ASTRO MEL™ NVV-3A, Aricel PC-6A, ASTRO MEL™ CR-1, and ASTRO SET™ 90. A suitable aminoplast resin can comprise a urea-formaldehyde resin.

Low-density microcapsules can be prepared by any suitable technique, including, for example, as described U.S. Pat. Nos. 8,816,023 and 8,993,691, each of which is incorporated by reference in its entirety. Coated low density microcapsules can be obtained, for example, by preparing an aqueous dispersion of microcapsules in water with a melamine resin, under stirring. A catalyst may then be added, and the dispersion heated to, for example, a temperature from 50° C. to 80° C. Low density microcapsules such as thermally expanded microcapsules having a polyacrylonitrile shell, de-ionized water and an aminoplast resin such as a melamine resin can be combined and mixed. A 10% w/w solution of para-toluene sulfuric acid in distilled water can then be added and the mixture reacted at 60° C. for about 2 hours. Saturated sodium bicarbonate can then be added, and the mixture stirred for 10 minutes. The solids can be filtered, rinsed with distilled water, and dried overnight at room temperature. The resulting powder of aminoplast resin-coated microcapsules can then be sifted through a 250 μm sieve to remove and separate agglomerates.

Prior to application of an aminoplast resin coating, a thermally expanded thermoplastic microcapsule can be characterized by a specific gravity, for example, within a range from 0.01 to 0.05, within a range from 0.015 to 0.045, within a range from 0.02 to 0.04, or within a range from 0.025 to 0.035, wherein the specific gravity is determined according to ISO 787 (Part 10). For example, Expancel® 920 DE 40 and Expancel® 920 DE 80 can be characterized by a specific gravity of about 0.03, wherein the specific gravity is determined according to ISO 787 (Part 10).

Following coating with an aminoplast resin, an aminoplast-coated microcapsule can be characterized by a specific gravity, for example, within a range from 0.02 to 0.08, within a range from 0.02 to 0.07, within a range from 0.02 to 0.06, within a range from 0.03 to 0.07, within a range from 0.03 to 0.065, within a range from 0.04 to 0.065, within a range from 0.045 to 0.06, or within a range from 0.05 to 0.06, wherein the specific gravity is determined according to ISO 787 (Part 10).

Aminoplast-coated microcapsules and method of making aminoplast-coated microcapsules are disclosed, for example in U.S. Application Publication No. 2016/0083619, which is incorporated by reference in its entirety.

Compositions provided by the present disclosure can comprise, for example, from 0.1 wt % to 6 wt %, from 0.5 wt % to 5 wt %, from 1 wt % to 4 wt %, or from 2 wt % to 4 wt % of a lightweight filler or combination of lightweight fillers, where wt % is based on the total weight of the composition. Compositions provided by the present disclosure can comprise, for example, from 1 vol % to 80 vol %, from 2 vol % to 60 vol %, from 5 vol % to 50 vol %, from 10 vol % to 40 vol %, or from 20 vol % to 40 vol %, of a lightweight filler or combination of lightweight fillers, where vol % is based on the total volume of the composition.

Compositions and sealants provided by the present disclosure can comprise an inorganic filler or combination of inorganic fillers. An inorganic filler can be included to provide mechanical reinforcement and to control the rheological properties of the composition. Inorganic fillers may be added to compositions to impart desirable physical properties such as, for example, to increase the impact strength, to control the viscosity, or to modify the electrical properties of a cured composition.

Inorganic fillers useful in compositions provided by the present disclosure and useful for aviation and aerospace applications include carbon black, calcium carbonate, precipitated calcium carbonate, calcium hydroxide, hydrated alumina (aluminum hydroxide), fumed silica, silica, precipitated silica, silica gel, and combinations of any of the foregoing. For example, an inorganic filler can include a combination calcium carbonate and fumed silica, and the calcium carbonate and fumed silica can be treated and/or untreated. An inorganic filler can comprise calcium carbonate and fumed silica.

An inorganic filler can be coated or uncoated. For example, an inorganic filler can be coated with a hydrophobic coating, such as a coating of polydimethylsiloxane.

Suitable calcium carbonate fillers include products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

A filler can include an electrically conductive filler or combination of electrically conductive fillers. Examples of suitable electrically conductive fillers include nickel powder, graphite, nickel-coated graphite, stainless steel, or a combination of any of the foregoing.

Compositions provided by the present disclosure can comprise an electrically conductive filler. Electrical conductivity and EMI/RFI shielding effectiveness can be imparted to composition by incorporating conductive materials within the polymer. The conductive elements can include, for example, metal or metal-plated particles, fabrics, meshes, fibers, and combinations thereof. The metal can be in the form of, for example, filaments, particles, flakes, or spheres. Examples of metals include copper, nickel, silver, aluminum, tin, and steel. Other conductive materials that can be used to impart electrical conductivity and EMI/RFI shielding effectiveness to polymer compositions include conductive particles or fibers comprising carbon or graphite. Conductive polymers such as polythiophenes, polypyrroles, polyaniline, poly(p-phenylene) vinylene, polyphenylene sulfide, polyphenylene, and polyacetylene can also be used. Electrically conductive fillers also include high band gap materials such as zinc sulfide and inorganic barium compounds.

Other examples of electrically conductive fillers include electrically conductive noble metal-based fillers such as pure silver; noble metal-plated noble metals such as silver-plated gold; noble metal-plated non-noble metals such as silver plated cooper, nickel or aluminum, for example, silver-plated aluminum core particles or platinum-plated copper particles; noble-metal plated glass, plastic or ceramics such as silver-plated glass microspheres, noble-metal plated aluminum or noble-metal plated plastic microspheres; noble-metal plated mica; and other such noble-metal conductive fillers. Non-noble metal-based materials can also be used and include, for example, non-noble metal-plated non-noble metals such as copper-coated iron particles or nickel-plated copper; non-noble metals, e.g., copper, aluminum, nickel, cobalt; non-noble-metal-plated-non-metals, e.g., nickel-plated graphite and non-metal materials such as carbon black and graphite. Combinations of electrically conductive fillers can also be used to meet the desired conductivity, EMI/RFI shielding effectiveness, hardness, and other properties suitable for a particular application.

The shape and size of the electrically conductive fillers used in the compositions of the present disclosure can be any appropriate shape and size to impart electrical conductivity and EMI/RFI shielding effectiveness to the cured composition. For example, fillers can be of any shape generally used in the manufacture of electrically conductive fillers, including spherical, flake, platelet, particle, powder, irregular, fiber, and the like. In certain sealant compositions of the disclosure, a base composition can comprise Ni-coated graphite as a particle, powder or flake. The amount of Ni-coated graphite in a base composition can range from 40 wt % to 80 wt % or can range from 50 wt % to 70 wt %, based on the total weight of the base composition. An electrically conductive filler can comprise Ni fiber. Ni fiber can have a diameter ranging from 10 μm to 50 μm and have a length ranging from 250 μm to 750 μm. A base composition can comprise, for example, an amount of Ni fiber ranging from 2 wt % to 10 wt %, or from 4 wt % to 8 wt %, based on the total weight of the base composition.

Carbon fibers, particularly graphitized carbon fibers, can also be used to impart electrical conductivity to compositions of the present disclosure. Carbon fibers formed by vapor phase pyrolysis methods and graphitized by heat treatment, and which are hollow or solid with a fiber diameter ranging from 0.1 micron to several microns, have high electrical conductivity. As disclosed in U.S. Pat. No. 6,184,280, carbon microfibers, nanotubes or carbon fibrils having an outer diameter of less than 0.1 μm to tens of nanometers can be used as electrically conductive fillers. An example of graphitized carbon fiber suitable for conductive compositions of the present disclosure include Panex® 30MF (Zoltek Companies, Inc., St. Louis, Mo.), a 0.921 μm diameter round fiber having an electrical resistivity of 0.00055 Ω-cm.

The average particle size of an electrically conductive filler can be within a range useful for imparting electrical conductivity to a polymer-based composition. For example, the particle size of the one or more fillers can range from 0.25 μm to 250 μm, can range from 0.25 μm to 75 μm, or can range from 0.25 μm to 60 μm. Composition provided by the present disclosure can comprise Ketjenblack© EC-600 JD (AkzoNobel, Inc., Chicago, Ill.), an electrically conductive carbon black characterized by an iodine absorption of 1,000 mg/g to 11,500 mg/g (J0/84-5 test method), and a pore volume of 480 cm³/100 g to 510 cm³/100 g (DBP absorption, KTM 81-3504). An electrically conductive carbon black filler is Black Pearls® 2000 (Cabot Corporation, Boston, MA).

Compositions of the present disclosure can comprise more than one electrically conductive filler and the more than one electrically conductive filler can be of the same or different materials and/or shapes. For example, a sealant composition can comprise electrically conductive Ni fibers, and electrically conductive Ni-coated graphite in the form of powder, particles or flakes. The amount and type of electrically conductive filler can be selected to produce a sealant composition which, when cured, exhibits a sheet resistance (four-point resistance) of less than 0.50 Ω/cm², or a sheet resistance less than 0.15 Ω/cm². The amount and type of filler can also be selected to provide effective EMI/RFI shielding over a frequency range of from 1 MHz to 18 GHz for an aperture sealed using a sealant composition of the present disclosure.

A composition can comprise, for example, from 0 wt % to 80 wt % of an electrically conductive filler or combination of electrically conductive fillers, such as from 10 wt % to 80 wt %, 20 wt % to 80 wt %, 30 wt % to 80 wt %, 40 wt % to 80 wt %, 50 wt % to 80 wt % or from 50 wt % to 70 wt %, where wt % is based on the total wt % of the sprayable composition.

A filler can be an electrically conductive filler and can be used to impart electrically conductivity and/or EMI/RFI shielding effectiveness to a three-dimensional printed object. For example, an electrically conductive printed object can be characterized by a sheet resistance less than 0.5 Ω/cm² or less 0.15 Ω/cm². For example, an electrically conductive printed object can provide effective EMI/RFI over a frequency range from 1 MHz to 18 GHz, or a subrange between 1 MHz to 18 GHz.

Compositions provided by the present disclosure can contain, for example, from 0.1 wt % to 90 wt %, from 0.1 wt % to 80 wt %, from 0.1 wt % to 70 wt %, from 1 wt % to 70 wt %, from 5 wt % to 60 wt %, from 10 wt % to 50 wt %, from 10 wt % to 40 w %, or from 20 wt % to 60 wt % of a filler or combination of fillers, where wt % is based on the total weight of the composition.

Sprayable compositions provided by the present disclosure can contain, for example, from 0.1 wt % to 90 wt %, from 1 wt % to 90 wt %, from 5 wt % to 90 wt %, from 10 wt % to 85 wt %, from 20 wt % to 80 w %, or from 30 wt % to 80 wt %, from 40 wt % to 80 wt %, from 50 wt % to 80 wt %, or from 60 wt % to 80 wt % of a filler or combination of fillers, where wt % is based on the total dry solids weight of the sprayable composition.

Cured compositions provided by the present disclosure can contain, for example, from 0.1 wt % to 90 wt %, from 1 wt % to 90 wt %, from 5 wt % to 90 wt %, from 10 wt % to 85 wt %, from 20 wt % to 80 w %, or from 30 wt % to 80 wt %, from 40 wt % to 80 wt %, from 50 wt % to 80 wt %, or from 60 wt % to 80 wt % of a filler or combination of fillers, where wt % is based on the total weight of the cured composition.

A coating composition provided by the present disclosure can comprise a UV stabilizer or a combination of UV stabilizers.

A UV stabilizer can include a UV absorber, a hindered amine light stabilizer, a benzoate, or a combination of any of the foregoing.

Examples of suitable UV stabilizers include UV absorbers and hindered amine light stabilizers. Examples of suitable UV stabilizers include products under the tradenames Cyasorb® (Solvay), Uvinul® (BASF), and Tinuvin® (BASF).

Examples of suitable UV absorbers include benzotriazoles, triazines, and benzophenones.

A sprayable composition can contain, for example, from 0.1 wt % to 3 wt %, from 0.2 wt % to 2.5 wt %, from 0.4 wt % to 2 wt %, or from 0.5 wt % to 1.5 wt % of a UV stabilizer or combination of UV stabilizers, where wt % is based on the total solids weight of the composition.

A cured composition can contain, for example, from 0.1 wt % to 3 wt %, from 0.2 wt % to 2.5 wt %, from 0.4 wt % to 2 wt %, or from 0.5 wt % to 1.5 wt % of a UV stabilizer or combination of UV stabilizers, where wt % is based on the total solids weight of the sprayable composition.

Compositions provided by the present disclosure can contain an antioxidant or combination of antioxidants.

An antioxidant can include phenolic antioxidants and phosphite-based antioxidants.

Examples of thermal stabilizers include sterically hindered phenolic antioxidants such as pentaerythrityl tetrakis[3-(3,5-di-tert-butyl-4-hydroxyphenyl)propionate](Irganox® 1010, BASF), triethylene glycol bis[3-(3-tert-butyl-4-hydroxy-5-methylphenyl)propionate](Irganox® 245, BASF), 3,3′-bis[3-(3,5-di-tert-butyl-4-hydroxyphenyl)propionohydrazide](Irganox® MD 1024, BASF), hexamethylene glycol bis[3-(3,5-di-tert-butyl-4-hydroxyphenyl)propionate](Irganox® 259, BASF), and 3,5-di-tert-butyl-4-hydroxytoluene (Lowinox® BHT, Chemtura).

A sprayable composition can contain, for example, from 0.1 wt % to 3 wt %, from 0.2 wt % to 2.5 wt %, from 0.4 wt % to 2 wt %, or from 0.5 wt % to 1.5 wt % of an antioxidant or combination of antioxidants, where wt % is based on the total weight of the composition.

A cured composition can contain, for example, from 0.1 wt % to 3 wt %, from 0.2 wt % to 2.5 wt %, from 0.4 wt % to 2 wt %, or from 0.5 wt % to 1.5 wt % of an antioxidant or combination of antioxidants, where wt % is based on the total solids weight of the sprayable composition.

A coating composition provided by the present disclosure can comprise an adhesion promoter or combination of adhesion promoters. Adhesion promoters can be included in a composition to increase the adhesion of the polymeric matrix to organic filler, inorganic filler, and to surfaces such as titanium composite surfaces, stainless steel surfaces, compositions, aluminum, and other coated and uncoated aerospace surfaces.

An adhesion promoter can include a phenolic adhesion promoter, a combination of phenolic adhesion promoters, an organo-functional silane, a combination of organo-functional silanes, hydrolyzed silanes, a combination of hydrolyzed silanes, or a combination of any of the foregoing. An organo-functional silane can be an amine-functional silane.

A coating composition provided by the present disclosure can comprise an organo-functional silane, a phenolic adhesion promoter, and a hydrolyzed organo-functional silane. Examples of suitable adhesion promoters include phenolic resins such as Methylon® phenolic resin, organo-functional silanes, such as epoxy-, mercapto- or amine-functional silanes, such as Silquest® organo-functional silanes, and hydrolyzed silanes.

A coating composition provided by the present disclosure can comprise a phenolic adhesion promoter, an organo-functional silane, or a combination thereof. A phenolic adhesion promoter can comprise a cooked phenolic resin, an un-cooked phenolic resin, or a combination thereof. Phenolic adhesion promoters can comprise the reaction product of a condensation reaction of a phenolic resin with one or more thiol-terminated polysulfides. Phenolic adhesion promoters can be thiol-terminated.

Examples of suitable cooked phenolic resins include T-3920 and T-3921, available from PPG Aerospace.

Examples of suitable phenolics that can be used to provide phenolic resins include 2-(hydroxymethyl)phenol, (4-hydroxy-1,3-phenylene)dimethanol, (2-hydroxybenzene-1,3,4-triyl) trimethanol, 2-benzyl-6-(hydroxymethyl)phenol, (4-hydroxy-5-((2-hydroxy-5-(hydroxymethyl)cyclohexa-2,4-dien-1-yl)methyl)-1,3-phenylene)dimethanol, (4-hydroxy-5-((2-hydroxy-3,5-bis(hydroxymethyl)cyclohexa-2,4-dien-1-yl)methyl)-1,3-phenylene)dimethanol, and a combination of any of the foregoing.

Suitable phenolic resins can be synthesized by the base-catalyzed reaction of phenol with formaldehyde.

Phenolic adhesion promoters can comprise the reaction product of a condensation reaction of a Methylon® resin, a Varcum® resin, or a Durez® resin, available from Durez Corporation, and/or a Bakelite® phenolic resin, with a thiol-terminated polysulfide such as a Thioplast® resin or a Thiokol® resin.

Examples of Methylon® resins include Methylon® 75108 (allyl ether of methylol phenol, see U.S. Pat. No. 3,517,082) and Methylon® 75202.

Examples of Varcum® resins include Varcum® 29101, Varcum® 29108, Varcum® 29112, Varcum® 29116, Varcum® 29008, Varcum® 29202, Varcum® 29401, Varcum® 29159, Varcum® 29181, Varcum® 92600, Varcum® 94635, Varcum® 94879, and Varcum® 94917.

An example of a Durez® resin is Durez® 34071. Bakelite® phenolic resins are available from Hexion.

Compositions provided by the present disclosure can comprise an organo-functional adhesion promoter such as an organo-functional silane. An organo-functional silane can comprise hydrolysable groups bonded to a silicon atom and at least one organo-functional group. An organo-functional silane can have the structure R^{a}—(CH₂)ₙ—Si(—OR)₃₋ₙRₙ, where R^{a} comprises an organo-functional group, n is 0, 1, or 2, and R is alkyl such as methyl or ethyl. Examples of suitable organo-functional groups include epoxy, amino, methacryloxy, or sulfide groups. An organo-functional silane can be a dipodal organo-functional silane having two or more silane groups. An organo-functional silane can be a combination of a monosilane and a dipodal silane.

An amine-functional silane can comprise a primary amine-functional silane, a secondary amine-functional silane, or a combination thereof. A primary amine-functional silane refers to a silane having primary amino group. A secondary amine-functional silane refers to a silane having a secondary amine group.

A secondary amine-functional silane can be a sterically hindered amine-functional silane. In a sterically hindered amine-functional silane the secondary amine can be proximate a large group or moiety that limits or restricts the degrees of freedom of the secondary amine compared to the degrees of freedom for a non-sterically hindered secondary amine. For example, in a sterically hindered secondary amine, the secondary amine can be proximate a phenyl group, a cyclohexyl group, or a branched alkyl group.

Amine-functional silanes can be monomeric amine-functional silanes having a molecular weight, for example, from 100 Daltons to 1000 Daltons, from 100 Daltons to 800 Daltons, from 100 Daltons to 600 Daltons, or from 200 Daltons to 500 Daltons.

Examples of suitable primary amine-functional silanes include 4-aminobutyltriethoxysilane, 4-amino-3,3-dimethylbutyltrimethoxysilane, N-(2-aminoethyl)-3-aminopropyltriethoxysilane, 3-(m-aminophenoxy)propyltrimethoxysilane, m-aminophenyltrimethoxysilane, p-aminophenyltrimethoxysilane, 3-aminopropyltriethoxysilane, 3-aminopropyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxysilylpropyl)pyrrole, 3-aminopropylsilanetriol, 4-amino-3,3-dimethylbutylmethyldimethoxysilane, 3-aminopropylmethyldiethoxysilane, 1-amino-2-(dimethylethoxysilyl)propane, 3-aminopropyldiisopropylene ethoxysilane, and 3-aminopropyldimethylethoxysilane.

Examples of suitable diamine-functional silanes include (aminoethyl)(aminomethyl)phenethyltrimethoxysilane and N-(2-aminoethyl)-3-aminopropyltrimethoxysilane.

Examples of suitable secondary amine-functional silanes include 3-(N-allylamino)propyltrimethoxysilane, n-butylaminopropyltrimethoxysilane, tert-butylaminopropyltrimethoxysilane, (N,N-cylohexylaminomethyl)methyldiethoxysilane, (N-cyclohexylaminomethyl)triethoxysilane, (N-cyclohexylaminopropyl)trimethoxysilane, (3-(n-ethylamino)isobutyl)methyldiethoxysilane, (3-(N-ethylamino)isobutyl)trimethoxysilane, N-methylaminopropylmethyldimethoxysilane, N-methylaminopropyltrimethoxysilane, (phenylaminomethyl)methyldimethoxysilane, N-phenylaminomethyltriethoxysilane, and N-phenylaminopropyltrimethoxysilane.

Suitable amine-functional silanes are commercially available, for example, from Gelest Inc. and from Dow Corning Corporation.

Examples of suitable amino-functional silanes include Silquest® A-187, Silquest® A-1100, and Silquest® A-1110, available from Momentive Performance Materials.

Suitable adhesion promoters also include sulfur-containing adhesion promoters such as those disclosed in U.S. Pat. Nos. 8,513,339; 8,952,124; and 9,056,949; and U.S. Application Publication No. 2014/0051789, each of which is incorporated by reference in its entirety.

Examples of suitable phenolic adhesion promoters include T-3920 and T-3921, available from PPG Aerospace.

An example of a suitable hydrolyzed silanes is T-1601 available from PPG Aerospace.

A coating composition provided by the present disclosure can comprise from 0.5 wt % to 4 wt %, from 0.5 wt % to 3.5 wt %, from 0.8 wt % to 3.2 wt %, from 1.0 wt % to 4.0 wt %, from 1.0 wt % to 3.0 wt %, from 1.5 wt % to 3.0 wt %, or from 1.7 wt % to 2.8 wt %, of an adhesion promoter or combination of adhesion promoters, where wt % is based on the total solids weight of the composition. For example, an adhesion promoter can comprise a combination of cooked phenolics, amino-functional silanes, and hydrolyzed silanes.

A coating composition provided by the present disclosure may comprise one or more additional components suitable for use in aerospace sealants and the selection can depend at least in part on the desired performance characteristics of the cured sealant under conditions of use. A coating composition provided by the present disclosure may further comprise one or more additives such as a plasticizer, a reactive diluent, a pigment, a solvent, or a combination of any of the foregoing.

A coating composition provided by the present disclosure may be formulated as a sealant. By formulated is meant that in addition to the reactive species forming the cured polymer network, additional material can be added to a composition to impart desired properties to the uncured sealant and/or to the cured sealant. For the uncured sealant these properties can include viscosity, pH, and/or rheology. For cured sealants, these properties can include weight, adhesion, corrosion resistance, color, glass transition temperature, electrical conductivity, cohesion, and/or physical properties such as tensile strength, elongation, and hardness. A coating composition provided by the present disclosure may comprise one or more additional components suitable for use in aerospace sealants and depend at least in part on the desired performance characteristics of the cured sealant under conditions of use.

A coating composition provided by the present disclosure can have a density equal to or less than 1.0 g/cm³, equal to or less than 1.2 g/cm³, equal to or less than 1.4 g/cm³, or equal to or less than 1.65 g/cm³, where density is determined according to ISO 2781.

A coating composition provided by the present disclosure can comprise, for example, from 5 wt % to 50 wt % of an isocyanate-functional polyurethane prepolymer provided by the present disclosure, and from 0.5 wt % to 10 wt % of a polyamine, where wt % is based on the total weight of the sprayable composition.

A coating composition provided by the present disclosure can comprise, for example, from 10 wt % to 30 wt % of an isocyanate-functional polyurethane prepolymer provided by the present disclosure, and from 2 wt % to 6 wt % of a polyamine, where wt % is based on the total solids weight of the sprayable composition.

A sprayable coating composition provided by the present disclosure can comprise, for example, from 20 wt % to 80 wt % of a filler, from 25 wt % to 75 wt %, from 20 wt % to 70 wt %, from 25 wt % to 65 wt %, from 30 wt % to 60 wt %, or from 35 wt % to 55 wt % of a filler, where wt % is based on the total solids weight of the sprayable composition. A sprayable coating composition can comprise greater than 10 wt % of a filler, greater than 30 wt %, greater than 50 wt %, or greater than 70 wt % of a filler, where wt % is based on the total solids weight of the sprayable composition.

A sprayable coating composition can comprise, for example, from 15 wt % to 50 wt % of a solvent, from 20 wt % to 45 wt %, or from 25 wt % to 40 wt % solvent, where wt % is based on the total weight of the sprayable coating composition.

A sprayable composition can comprise, for example, from 150 g/L to 250 g/L prepolymer, 16.22 wt % solvent.

A coating composition provided by the present disclosure can include a one-part, a two-part, or a three-part system. In a one-part system the components can be combined and stored prior to use. In a two-part system, a first part and a second part can be stored separately and combined prior to use. For example, a first part can comprise primarily the solid content including, for example, the isocyanate-terminated chain-extended polythioether, filler, UV package, blocked catalyst, and optionally some solvent; and the second part can comprise solvent that is combined with the first part prior to use. In a three-part system, the first part can comprise, for example, the isocyanate-terminated chain-extended polythioether, filler, and UV package; and a second part comprising solvent, and a third part comprising a catalyst can be combined prior to use.

A coating system provided by the present disclosure can be provided as a two-part (2K) system having an isocyanate component and a polyamine component. The isocyanate component can comprise an isocyanate-functional polyurethane prepolymer provided by the present disclosure and the polyamine component can comprise a polyamine curing agent. The isocyanate component and the polyamine component can independently comprise one or more additives such as any of the additives disclosed herein. Solvent can be added to the isocyanate component and/or to the polyamine component before use or during use.

The isocyanate component and the polyamine component can be combined and mixed immediately before use or during use to provide a coating composition provided by the present disclosure.

A coating composition provided by the present disclosure can be a sprayable coating composition.

A coating composition provided by the present disclosure may not be sprayable and can be applied to a substrate using other methods such as roller coating, brushing, or painting.

A coating composition provided by the present disclosure can be provided as a two-part composition having an isocyanate component and an amine component.

An isocyanate component can comprise, for example, an isocyanate-functional polyurethane prepolymer provided by the present disclosure, filler, solvent and a UV stabilizer.

An amine component can comprise, for example, a polyamine.

A third component can comprise a solvent or combination of solvents.

For sprayable coating and sealant compositions, a curable composition can have a viscosity, for example, from 15 cps to 100 cps (0.015 Pa-sec to 0.1 Pa-sec), such as from 20 cps to 80 cps (0.02 Pa-sec to 0.08 Pa-sec) at 25° C.

A composition provided by the present disclosure may be used, for example, in sealants, coatings, encapsulants, and potting compositions. A sealant includes a composition capable of producing a film that has the ability to resist operational conditions, such as moisture and temperature, and at least partially block the transmission of materials, such as water, fuel, and other liquids and gases. A coating can comprise a covering that is applied to the surface of a substrate to, for example, improve the properties of the substrate such as the appearance, adhesion, wettability, corrosion resistance, wear resistance, fuel resistance, and/or abrasion resistance. A sealant can be used to seal surfaces, smooth surfaces, fill gaps, seal joints, seal apertures, and other features. A potting composition can comprise a material useful in an electronic assembly to provide resistance to shock and vibration and to exclude moisture and corrosive agents. Sealant compositions provided by the present disclosure are useful, e.g., to seal parts on aerospace vehicles that can come into contact with phosphate ester hydraulic fluids such as Skydrol®.

Compositions provided by the present disclosure can be used as coatings or as sealant.

A coating can be single coating or can be a layer of a multi-layer coating. As a coating layer of a multi-layer coating, a coating layer can be an inner layer coating, or can be a topcoat.

As sprayable coatings, the high isocyanate content of the sprayable composition facilitates the ability of the exterior of the coating to rapidly cure to provide a tack-free surface. Rapid curing can prevent coating sag and facilitate handling of the part while the coating is being fully cured. The high cross-linking density of the cured polymer can facilitate the incorporation of a high filler content with high tensile strength and % elongation.

Cured coatings provided by the present disclosure can exhibit, for example, a tensile strength greater than 1,000 psi, greater than 1,500 psi, greater than 2,000 psi, or greater than 2,500 psi, where tensile strength is determined according to ASTM D-412.

Cured coatings provided by the present disclosure can exhibit, for example, a tensile strength within a range from 1,000 psi to 3,000 psi (6.89 MPa to 20.68 MPa), from 1,250 psi to 2,750 psi (8.62 MPa to 18.96 MPa), from 1,500 psi to 2,500 psi (10.34 MPa to 17.24 MPa), or from 1,750 psi to 2,250 psi (12.06 MPa to 15.51 MPa), where tensile strength is determined according to ASTM D-412.

Cured coatings provided by the present disclosure can exhibit, for example, a % elongation greater than 50%, greater than 100%, greater than 150%, greater than 200%, or greater than 250%, where % elongation is determined according to ASTM D-412.

Cured coatings provided by the present disclosure can exhibit, for example, a % elongation from 50% to 300%, from 75% to 275%, from 100% to 250%, or from 125% to 225%, where % elongation is determined according to ASTM D-412.

Cured coatings, following immersion in aerospace fluids can exhibit a % volume swell less than 12.5%, less than 10%, less than 7.5%, less than 5%, less than 2.5%, or less than 1.5%, where % volume swell is determined according to methods as described in the present examples.

Cured coatings, following immersion in aerospace fluids can exhibit, for example, a % volume swell from 1% to 12.5%, from 1% to 10%, from 1% to 7.5%, from 1% to 5%, or from 1% to 2.5%, where % volume swell is determined according to methods as described in the present examples.

Cured coatings, following immersion in aerospace fluids can exhibit, for example, a % weight gain less than 12.5%, less than 10%, less than 7.5%, less than 5%, less than 2.5%, or less than 1.5%, where % weight gain is determined as described in the present examples.

Cured coatings, following immersion in aerospace fluids can exhibit, for example, a % weight gain from 1% to 12.5%, from 1% to 10%, from 1% to 7.5%, from 1% to 5%, or from 1% to 2.5%, where % weight gain is determined according to methods as described in the present examples.

Examples of aerospace fluids include JP-8, JRF Type I, lubrication oil, hydraulic fluid such as Skydrol® LD-4.

Cured coatings, following immersion in aerospace fluids, can exhibit, for example, a % volume swell less than 10%, less than 7.5%, or less than 5%; and a % weight gain less than 7.5%, less than 5%, or less than 2.5%, where % volume swell is determined according to methods as described in the present examples, and % weight gain is determined according to methods as described in the present examples.

Cured coatings, following immersion in aerospace fluids, can exhibit, for example, a tensile strength greater than 1,000 psi, greater than 1,500 psi, or greater than 2,000 psi; a % elongation greater than 75%, greater than 100%, greater than 200%, or greater than 300%; a % volume swell less than 10%, less than 7.5%, or less than 5%; and a % weight gain less than 7.5%, less than 5%, or less than 2.5%, where % volume swell is determined according to methods as described in the present examples and % weight gain is determined according to methods as described in the present examples.

Curable compositions provided by the present disclosure can be used as aerospace sealants or coatings, and in particular, as sealants or coatings where resistance to hydraulic fluid is desired. A sealant refers to a curable composition that has the ability when cured to resist atmospheric conditions such as moisture and temperature and at least partially block the transmission of materials such as water, water vapor, fuel, solvents, and/or liquids and gases.

Compositions provided by the present disclosure may be applied directly onto the surface of a substrate or over an underlayer such as a primer by any suitable coating process. Compositions, including sealants, provided by the present disclosure may be applied to any of a variety of substrates. Examples of substrates to which a composition may be applied include metals such as titanium, stainless steel, steel alloy, aluminum, and aluminum alloy, any of which may be anodized, primed, organic-coated or chromate-coated; epoxy; urethane; graphite; fiberglass composite; Kevlar®; acrylics; and polycarbonates. Compositions provided by the present disclosure may be applied to a substrate such as aluminum and aluminum alloy.

Furthermore, methods are provided for sealing an aperture utilizing a composition provided by the present disclosure. These methods comprise, for example, applying the curable composition to at least one surface of a part; and curing the applied composition to provide a sealed part.

Sealant compositions provided by the present disclosure may be formulated as Class A, Class B, or Class C sealants. A Class A sealant refers to a brushable sealant having a viscosity of 1 poise to 500 poise (0.1 Pa-sec to 50 Pa-sec) and is designed for brush application. A Class B sealant refers to an extrudable sealant having a viscosity from 4,500 poise to 20,000 poise (450 Pa-sec to 2,000 Pa-sec) and is designed for application by extrusion via a pneumatic gun. A Class B sealant can be used to form fillets and sealing on vertical surfaces or edges where low slump/slag is required. A Class C sealant has a viscosity from 500 poise to 4,500 poise (50 pa-sec to 450 Pa-sec) and is designed for application by a roller or combed tooth spreader. A Class C sealant can be used for fay surface sealing. Viscosity can be measured according to Section 5.3 of SAE Aerospace Standard AS5127/1C published by SAE International Group.

Furthermore, methods are provided for sealing an aperture utilizing a composition provided by the present disclosure. These methods comprise, for example, providing the curable composition of the present disclosure; applying the curable composition to at least one surface of a part; and curing the applied composition to provide a sealed part.

A composition provided by the present disclosure may be cured under ambient conditions, where ambient conditions refers to a temperature from 20° C. to 25° C., and atmospheric humidity. A composition can be cured under conditions encompassing a temperature from a 0° C. to 100° C. and humidity from 0% relative humidity to 100% relative humidity. A composition can be cured at a higher temperature such as at least 30° C., at least 40° C., or at least 50° C. A composition may be cured at room temperature, e.g., 25° C. The methods may be used to seal apertures on aerospace vehicles including aircraft and aerospace vehicles.

Apertures, surfaces, joints, fillets, fay surfaces including apertures, surfaces, fillets, joints, and fay surfaces of aerospace vehicles, sealed with compositions provided by the present disclosure are also disclosed. The compositions and sealants can also be used to seal fasteners.

The time to form a viable seal using curable compositions of the present disclosure can depend on several factors as can be appreciated by those skilled in the art, and as defined by the requirements of applicable standards and specifications. In general, curable compositions of the present disclosure develop adhesion strength within about 3 days to about 7 days following mixing and application to a surface at a temperature of 25° C. In general, full adhesion strength as well as other properties of cured compositions of the present disclosure become fully developed within 7 days at a temperature of 25° C. following mixing and application of a curable composition to a surface.

A cured composition can have a thickness, for example, from 5 mils to 25 mils (127 μm to 635 μm) such as from 10 mils to 20 mils (254 μm to 508 μm).

Prior to environmental exposure a cured sealant provided by the present disclosure can exhibit a density less than 1.2 g/cm³ (specific gravity less than 1.2) as determined according to ISO 2781, a tensile strength greater than 1 MPa determined according to ISO 37, a tensile elongation greater than 150% determined according to ISO 37, and a hardness greater than Shore 40A determined according to ISO 868, where the tests are performed at a temperature within a range of 21° C. to 25° C., and a humidity from 45% RH to 55% RH.

Following exposure to aviation fuel (JRF Type 1) according to ISO 1817 for 168 hours at 60° C., a cured sealant provided by the present disclosure can exhibit a tensile strength greater than 1.4 MPa determined according to ISO 37, a tensile elongation greater than 150% determined according to ISO 37, and a hardness greater than Shore 30A determined according to ISO 868, where the tests are performed at a temperature within a range of 21° C. to 25° C., and a humidity from 45% RH to 55% RH.

Following exposure to 3% aqueous NaCl for 168 hours at 60° C., a cured sealant provided by the present disclosure can exhibit a tensile strength greater than 1.4 MPa determined according to ISO 37, a tensile elongation greater than 150% determined according to ISO 37, and a hardness greater than Shore 30A determined according to ISO 868, where the tests are performed at a temperature within a range of 21° C. to 25° C., and a humidity from 45% RH to 55% RH.

Following exposure to de-icing fluid according to ISO 11075 Type 1 for 168 hours at 60° C., a cured sealant provided by the present disclosure can exhibit a tensile strength greater than 1 MPa determined according to ISO 37, and a tensile elongation greater than 150% determined according to ISO 37, where the tests are performed at a temperature within a range of 21° C. to 25° C., and a humidity from 45% RH to 55% RH.

Following exposure to phosphate ester hydraulic fluid (Skydrol® LD-4) for 1,000 hours at 70° C., a cured sealant provided by the present disclosure can exhibit a tensile strength greater than 1 MPa determined according to ISO 37, a tensile elongation greater than 150% determined according to ISO 37, and a hardness greater than Shore 30A determined according to ISO 868, where the tests are performed at a temperature within a range of 21° C. to 25° C., and a humidity from 45% RH to 55% RH.

Apertures, surfaces, joints, fillets, fay surfaces including apertures, surfaces, fillets, joints, and fay surfaces of aerospace vehicles, sealed with compositions provided by the present disclosure are also disclosed. A composition provided by the present disclosure can be used to seal a part. A part can include multiple surfaces and joints. A part can include a portion of a larger part, assembly, or apparatus. A portion of a part can be sealed with a composition provided by the present disclosure, or the entire part can be sealed.

Compositions provided by the present disclosure can be used to seal parts exposed or potentially exposed to fluids such as solvents, hydraulic fluids, and/or fuel.

Compositions provided by the present disclosure can be used to seal a part including a surface of a vehicle.

The term “vehicle” is used in its broadest sense and includes all types of aircraft, spacecraft, watercraft, and ground vehicles. For example, a vehicle includes aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, trains, and railroad cars. A vehicle can also include watercraft such as, for example, ships, boats, and hovercraft.

A composition provided by the present disclosure can be used in a F/A-18 jet or related aircraft such as the F/A-18E Super Hornet and F/A-18F (produced by McDonnell Douglas/Boeing and Northrop); in the Boeing 787 Dreamliner, 737, 747, 717 passenger jet aircraft, an related aircraft (produced by Boeing Commercial Airplanes); in the V-22 Osprey; VH-92, S-92, and related aircraft (produced by NAVAIR and Sikorsky); in the G650, G600, G550, G500, G450, and related aircraft (produced by Gulfstream); and in the A350, A320, A330, and related aircraft (produced by Airbus). Compositions provided by the present disclosure can be used in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd.; produced by Eclipse Aviation Corporation; or produced by Eclipse Aerospace (Kestrel Aircraft).

Compositions provided by the present disclosure can be used to seal parts and surfaces of vehicles such as fuel tank surfaces and other surfaces exposed to or potentially exposed to aerospace solvents, aerospace hydraulic fluids, and aerospace fuels.

The present invention includes parts sealed with a composition provided by the present disclosure, and assemblies and apparatus comprising a part sealed with a composition provided by the present disclosure.

The present invention includes vehicles comprising a part such as a surface sealed with a composition provided by the present disclosure. For example, an aircraft comprising a fuel tank or portion of a fuel tank sealed with a sealant provided by the present disclosure is included within the scope of the invention.

Compositions can be as coatings or sealants, and in particular sprayable coatings and sealants having a high filler content such as, for example, a filler content from 1 wt % to 90 wt % and/or a filler content from 1 vol % to 80 vol %. The coatings and sealants can be applied to any suitable surface including for example, surfaces of vehicles, architectural surfaces, consumer products, electronic products, marine equipment, and industrial equipment.

### EXAMPLES

Embodiments provided by the present disclosure are further illustrated by reference to the following examples, which describe isocyanate-functional polyurethane prepolymers, coating compositions comprising the isocyanate-functional polyurethane polycarbonate prepolymers, and uses of such compositions. It will be apparent to those skilled in the art that many modifications, both to materials and methods, may be practiced without departing from the scope of the disclosure.

### Example 1

### Synthesis of Isocyanate-Functional Polyurethane Polycarbonate Prepolymer (1)

A 1,000-mL four-necked round-bottomed flask equipped with a thermometer, mechanical stirrer, nitrogen gas inlet and condenser was charged with 235 gm (0.2471 equiv.) of Eternacoll® PH 200D (a polymeric polycarbonate diol available from UBE), 13.39 gm (0.0535 equiv.) of Capa® 4101 (tetra-functional polyol available from Perstorp), 21.15 gm (0.2644 equiv.) of PD-9 (2,4-diethyl-1,5-pentanediol, non-linear short chain diol available from KH Neochem Co. Ltd.), 174.26 gm (1.2377 equiv.) of Desmodur® W (H₁₂MDI diisocyanate available from Covestro AG), and 80.8 gm of methyl N-amyl ketone. The flask was purged with nitrogen and the contents were heated to 50° C. At 50° C., 0.0185 gm of dibutyltin dilaurate was added to the reactor contents. The reaction was exothermic. The batch temperature was increased to 70-75° C. and maintained at the temperature for two hours. After two hours, the NCO value was determined by indirect titration. The NCO value of the resulted prepolymer was 6.10. The viscosity was 37,300 cps 37,300 mPa-s) at 25° C. measured using a Brookfield viscometer with Spindle #2 at 2 rpm.

### Example 2

### Synthesis of Isocyanate-Functional Polyurethane Polycarbonate Prepolymer (2)

A 1000-mL four-necked round-bottomed flask equipped with a thermometer, mechanical stirrer, nitrogen gas inlet and condenser was charged with 228.0 gm (0.2398 equiv.) of Desmophen® C 2202 (a polymeric polycarbonate diol available from Covestro AG), 11.74 gm (0.0469 equiv.) of Capa® 4101 (tetra-functional polyol available from Perstorp), 8.77 gm (0.1096 equiv.) of PD-9 (non-linear short chain diol, 4-diethyl-1,5-pentanediol, available from KH Neochem Co. Ltd.), 122.23 gm (0.9313 equiv.) of Desmodur® W (H₁₂MDI diisocyanate available from Covestro AG), and 71.0 gm of methyl N-amyl ketone. The flask was purged with nitrogen and the contents were heated to 60° C. At 60° C., 0.0185 grams of dibutyltin dilaurate was added to the reactor contents. The reaction was exothermic. The temperature was increased to 70-75° C. and maintained for one hour. After one hour, the NCO value was determined by indirect titration. The NCO value of the resulted prepolymer was 5.09. The viscosity was 22,400 cps (22,400 mPa-s) at 49° C. measured using a Brookfield viscometer with Spindle #2 at 2 rpm.

### Example 3

### Synthesis of Isocyanate-Functional Polyurethane Polycarbonate Prepolymer (3)

A 1000-mL four-necked round-bottomed flask equipped with a thermometer, mechanical stirrer, nitrogen gas inlet and condenser was charged with 228.0 grams (0.2284 equiv.) of Placell® CD-220 (a polymeric polycarbonate diol available from Daicel Corporation), 11.74 gm (0.0469 equiv.) of Capa® 4101 (tetra-functional polyol available from Perstorp), 8.77 gm (0.1096 equiv.) of PD-9 (KH Neochem), 118.72 gm (0.9045 equiv.) of Desmodur® W (H₁₂MDI diisocyanate available from Covestro AG), and 71.0 gm of methyl N-amyl ketone. The flask was purged with nitrogen and the contents were heated to 60° C. At 60° C., 0.0185 gm of dibutyltin dilaurate was added to the reactor contents. The reaction was exothermic. The temperature was increased to a 70-75° C. and maintained for one hour. The reaction was exothermic. After one hour, the NCO value was determined by indirect titration. The NCO value of the resulting prepolymer was 4.90. The viscosity was 58,400 cps (58,400 mPa-s) at 49° C. measured using a Brookfield viscometer with Spindle #2 at 1 rpm.

### Example 4

### Polyisocyanate and Polyamine Components

The of isocyanate-functional polyurethane polycarbonate-based prepolymers of Examples 1-3 (100 g) were independently mixed with filler (207 g), methyl-N-amyl ketone (6.0 gm), and a UV stabilization package (4.0 gm). The materials were mixed at room temperature (23-25° C.) and stored under a nitrogen atmosphere.

TABLE 1
Isocyanate component.

| Materials | Weight (g) | Weight (%) |
|---|---|---|
| Isocyanate-functional polyurethane | 100 | 25.24 |
| polycarbonate prepolymer | | |
| Filler | 207 | 65.30 |
| Solvent | 6 | 8.20 |
| UV Package | 4 | 1.26 |
| Total | 317 | 100.00 |

Methyl-N-amylketone (20.0 g, MAK), acetone (80.0 g), and a polyamine curing agent (13.27 g, 0.0477 mol, Ethacure® 100) were added and mixed for 5 min at room temperature (23-25° C.)

TABLE 2
Amine component

| Materials | Weight (g) | Weight (%) |
|---|---|---|
| Polyamine curing agent | 13.27 | 11.7 |
| Solvents | 100 | 88.3 |
| Total | 113.27 | 100.00 |

### Example 5

### Sprayable Coating

Each sprayable coating composition was a combination of three parts, which were combined and mixed prior to application. Part A included an unblocked polyamine curing agent, Ethacure® 100. Part B included the isocyanate-terminated chain-extended prepolymer, filler, solvent, and a UV stabilizer package described in Example 4.

Part C included solvent. The contents of the sprayable compositions are provided in Table 3.

TABLE 3
Sprayable compositions.

| Component | Type | Weight (kg) | Weight (%) |
|---|---|---|---|
| Part B | Isocyanate-functional | 25.24 | 18.6 |
| | polyurethane | | |
| | polycarbonate prepolymer | | |
| | Filler | 65.30 | 48.1 |
| | Solvents | 8.20 | 6.0 |
| | UV Package | 1.26 | 0.9 |
| Part C | Methyl-n-amylketone | 6.31 | 4.6 |
| | Acetone | 25.23 | 18.6 |
| Part A | Amine Curing Agent | 4.18 | 3.1 |
| Total | | 135.72 | 100.0 |

Test samples were prepared by spraying multiple layers of the sprayable coating composition, such as from 20 to 30 layers, onto a substrate to build up a coating layer from 40 mils to 460 mils thick (1.02 mm to 1.52 mm). The solvent was allowed to evaporate at room temperature between each layer application. The applied coating composition was then cured for 7 days at 20° C. to 25° C.

Tensile strength and elongation measurements were determined according to ASTM method D412.4554. For aerospace coatings it is desirable that the tensile strength be at least 1,500 psi (10.34 MPa), and the elongation be, for example, greater than 75%, greater than 100%, or greater than 125%.

### Example 6

### Solvent Resistance

The curable compositions of Example 5 are spray-coated onto test panels to a total thickness from 40 mils to 60 mils (1.02 mm to 1.52 mm). Layers of coating are sprayed onto as substrate at a thickness of about 5 mils (0.127 mm) with a flash off time of between about 7 min and 10 min. The coatings are fully cured at room temperature (21° C. to 25° C.) for 7 days.

After the coatings are fully cured the samples are immersed in various aerospace fluids for 7 days at 60° C. The volume and mass of the coatings are measured before and after immersion in the aerospace fluids.

Volume swell and weight gain measurements are performed by weighing a 2-inch×1-inch cured sample before immersion in air and while suspended in water. The samples are placed into various aerospace fluids for 7 days at 140° F. (60° C.) and tested both in air and while suspended in water to determine weight gain and volume swell of the samples.

JP-8 is a kerosene-based military aviation jet fuel.

MIL-PRF-23699 Lube Oil gas turbine lubricant.

Skydrol® is a fire-resistant hydraulic fluid based on phosphate ester chemistry. Skydrol® fluids include Skydrol® 500B-4, Skydrol® LD-4, Skydrol® 5, and Skydrol® PE-5 are commercially available from Eastman Chemical Company.

For an aerospace coating, both the % volume swell and % weight gain should be no greater than 7.5%, and preferably less than 5%.

### Example 7

### Synthesis of Comparative Isocyanate-Functional Polythioether-Based Polyurethane Prepolymer

An isocyanate-functional polythioether-based polyurethane prepolymer was prepared according to the methods described in Examples 1-3 of U.S. Application Publication No. 2020/0010719 A1.

### Example 1: Synthesis of Thiol-Terminated Polythioether

A thiol-terminated polythioether was synthesized according to the method described in Example 1 of U.S. Pat. No. 6,172,179.

In a 2 L flask, 524.8 g (3.32 mol) of diethylene glycol divinyl ether (DEG-DVE) and 706.7 g (3.87 mol) of dimercaptodioxaoctane (DMDO) were mixed with 19.7 g (0.08 mol) of triallylcyanurate (TAC) and heated to 77° C. To the heated reaction mixture was added 4.6 g (0.024 mol) of an azobisnitrile free radical catalyst (Vazo® 67, 2,2′-azobis-2-methylbutyronitrile). The reaction proceeded substantially to completion after 2 h to afford 1,250 g (0.39 mol, yield 100%) of a liquid polythioether resin having a T_{g} of −68° C. and a viscosity of 65 poise (6.5 Pa-sec). The resin was water white clear.

### Example 2: Synthesis of Hydroxyl-Terminated Polythioether Prepolymer

A hydroxyl-terminated polythioether was synthesized according to the method described in Example 2 of U.S. Pat. No. 9,518,197.

A 1-L, 4-neck round-bottomed flask was fitted with a mantle, thermocouple, temperature controller, nitrogen line, mechanical stirrer and dropping funnel. The flask was charged with a thiol-terminated polythioether (1) (652.30 g) prepared according to Example 1. The flask was heated to 71° C. under nitrogen and stirred at 300 rpm. A mixture of 4-hydroxybutyl vinyl ether (47.40 g) and Vazo®-67 (1.19 g) was added to the flask in 1 h via a dropping funnel. The reaction mixture was maintained at 71° C. for 41 h, at which time the reaction was complete. After this, the reaction apparatus was then fitted with a vacuum line and the product heated to 94° C. Heating was continued for 1.3 hours under vacuum. Following vacuum treatment, a pale yellow, viscous polythioether polyol (678.80 g) was obtained. The polythioether polyol had a hydroxyl number of 31.8 using the potassium hydroxyl neutralization method, and a viscosity of 77 poise (7.7 Pa-sec), measured using a Brookfield CAP 2000 viscometer, spindle #6, at 25° C., and 300 rpm.

### Example 3: Synthesis of Isocyanate-Terminated Chain-Extended Polythioether Prepolymer (3)

A 1-liter, 4-neck round bottom flask was fitted with a mantle, thermocouple, nitrogen line and mechanical stirrer. The flask was charged with a thiol-terminated polythioether (1) (345.13 g, 0.1077 mol) prepared according to Example 1. The flask was then charged with (14.0 g, 0.9875 mol) of 2-butyl-2-ethyl-1,3-propanediol (BEPD, Perstorp and KH NeoChem Inc.) followed by the addition of Desmodur® W (H₁₂MDI from Covestro) or Vestanat® H₁₂MDI (from Evonik Industries) (152.41 g, 0.58 mol) (300 mol % excess isocyanate to thiol and hydroxyl groups). The solvent content (methyl amyl ketone) at was about 18-20%. The reactor contents were stirred and heated to about 60° C. At 60° C. a trimerization catalyst, a solution of 50% N,N′-dimethylcyclohexylamine (DMCHA, Polycat® 8 from Evonik Industries, Jeffcat® from Huntsman, or Niax® Catalyst C-8 from Momentive) in methyl amyl ketone (0.08 g) was added and mixed for 60 minutes. The batch temperature was kept about 68-74° C. After one hour, a sample was taken from the batch and the isocyanate content determined by indirect titration. At this stage of the reaction about 20% to 25% of the diisocyanates were converted into trimers. The temperature of the batch was then increased to 85-90° C. and the reactor contents was mixed for another 150 min. At the end of this time period the isocyanate value remained unchanged.

The temperature of the batch was then decreased to about 74-75° C. and a solution of 50% dibutyltin dilaurate in methyl amyl ketone (0.03 g) (Sigma Aldrich) was added. The temperature of the reaction was maintained at 75-80° C. and mixed for about 100 min. The resulting H₁₂MDI-terminated chain-extended polythioether prepolymer had an isocyanate content/value of 5.0%, measured using indirect titration, and a viscosity of about 200 cps (0.2 Pa-sec) at room temperature (23-25° C.), measured using a Brookfield CAP 2000 viscometer, spindle #6, at 25° C., and 300 rpm.

### Example 8

### Comparative Properties

The properties of a coating composition prepared using an isocyanate-functional polyurethane polythioether-based prepolymer (Example 7) and an isocyanate-functional polyurethane polycarbonate-based prepolymer (Example 3).

Sprayable sealants were prepared as described in Example 5 using either the isocyanate-functional polythioether-based polyurethane prepolymer described in Example 7 or the isocyanate-functional polycarbonate-based polyurethane prepolymer described in Example 3.

Test samples were prepared by spraying multiple layers, such as from 20 layers to 30 layers of the coating to build up a coating layer from 20 mils to 40 mils thick (0.51 mm to 1.02 mm). The solvent was allowed to evaporate at room temperature between each layer application. The coating was then cured for 7 days at 20° C. to 25° C.

The results are presented in Table 4.

TABLE 4
Comparison of sealants prepared using polythioether-
based or polycarbonate-based prepolymers.

| | Composition with | Composition with |
|---|---|---|
| | Polythioether-Based | Polycarbonate-Based |
| | Prepolymer | Prepolymer |
| | Example 7 | Example 3 |
| ¹ Fluid immersion | | |
| Mil-PRF 23699 Lube Oil | Acceptable (<10%) | Excellent (<5%) |
| Jet Fuel JP-8 | Acceptable (<10%) | Excellent (<5%) |
| Acetone Extraction | Acceptable | Excellent |
| Gloss retention after immersion | Gloss change visible | No visible gloss |
| | | change |
| Initial 60° Gloss | — | 5.8 |
| Mil-PRF 23699 Lube Oil (34 days) | — | 7.7 |
| Jet Fuel JP-8 (34 days) | — | 6.8 |
| QUV Exposure @ 300 hours | >3.0 after 300 hours | <2.0 after 1000 hours |
| Initial 20° Gloss | | 0.8 |
| Final 20° Gloss | discolored | 0.8 |
| Initial 60° Gloss | | 8.5 |
| Final 60° Gloss | discolored | 7.5 |
| Tensile/Elongation | Acceptable | Excellent |
| Weathering/ΔE | Very Poor | Excellent |
| Flexibility after Load | Good | Good |
| SO₂ Salt Fog @ 3,000 Hours | Untested - Expected | Excellent |
| | Good/Excellent | |
| Sample Formulation | | |
| Tensile Strength (psi \| MPa) | 3003 \| 20.7 | 7409 \| 51.1 |
| % Elongation | 262 | 253 |
| Sample Formulation After 336 | | |
| Hours @ 250° F. (121° C.) | | |
| Tensile Strength (psi \| MPa) | 2493 \| 17.2 | 7337 \| 50.6 |
| % Elongation | 165 | 246 |

¹ Weight gain and volume swell.

The curable composition of Example 8 was spray-coated onto test panels to a total thickness from 40 mils to 60 mils (1.02 mm to 1.52 mm). Layers of coating were sprayed onto as substrate at a thickness of about 5 mils (0.127 mm) with a flash off time of between about 7 min and 10 min. The coatings were fully cured at room temperature (21° C. to 25° C.) for 7 days.

After the coatings were fully cured the samples were immersed in various aerospace fluids for 7 days at 60′° C. The volume and mass of the coatings were measured before and after immersion in the aerospace fluids. The results are presented in Table 6.

Tensile strength and % elongation are determined according to ASTM method D412.4554.

Volume Swell and weight gain measurements were performed by weighing a 2-inch×1-inch cured sample before immersion in air and while suspended in water. The samples were placed into various aerospace fluids for 7 days at 140° F. (60° C.) and tested both in air and while suspended in water to determine weight gain and volume swell of the samples. The results are provided in Table 6.

JP-8 is a kerosene-based military aviation jet fuel.

MIL-PRF-23699 Lube Oil gas turbine lubricant.

Skydrol® is a fire-resistant hydraulic fluid based on phosphate ester chemistry. Skydrol® fluids include Skydrol® 500B-4, Skydrol® LD-4, Skydrol® 5, and Skydrol® PE-5 are commercially available from Eastman Chemical Company.

For an aerospace coating, both the % volume swell and % weight gain should be no greater than 7.5%, and preferably less than 5%.

Gloss Retention is measured according to ASTM D523 Standard Test method for Specular Gloss at an angle of 60°.

Acetone Extraction was performed by exposing a film to boiling acetone in a Soxhlet Extractor for from 8 hours to 24 hours and determining the amount of low molecular species extracted from the film.

QUV accelerated testing is performed in accordance with ASTM 4329 (ASTM D4587, ISO 4892) by subjecting test panels to continuous cycles of intense ultraviolet radiation for 8 hours at 70° C. followed by 4 hours at 45° C. for up to 1,000 hours.

Weathering is evaluated according to ASTM G154/G155.

Flexibility under load can be determined according to ASTM D790.

SO₂ salt fog evaluation is determined according to G85:A4.

### Example 9

### Evaluation of Long-Term Heat Exposure of Casted Films on Tensile and Elongation

The tensile strength and elongation of coatings prepared using an isocyanate-functional polyurethane polythioether-based prepolymer (Example 7) and an isocyanate-functional polyurethane polycarbonate-based prepolymer (Example 3) following long term exposure to 250° F. (121° C.) was evaluated.

Sprayable sealants were prepared as described in Example 5 using either the isocyanate-functional polythioether-based polyurethane prepolymer described in Example 3 or the isocyanate-functional polythioether-based polyurethane prepolymer described in Example 8.

Test samples were prepared by spraying multiple layers, such as from 20 to 30 layers, of the coating to build up a coating layer from 20 mils to 40 mils thick (0.51 mm to 1.02 mm). The solvent was allowed to evaporate at room temperature (20° C. to 25° C.) between each layer application. The coating was then cured for 7 days at 20° C. to 25° C.

The test samples were then exposed to 250° F. (121° C.) for 12 weeks.

The results are presented in Tables 5 and 6.

TABLE 5
Tensile strength.

| | | Tensile Strength | | | | | | |
|---|---|---|---|---|---|---|---|---|
| | | Percent of Initial | | | | | | |
| | Curing | Initial/RT | 2 | 4 | 6 | 8 | 10 | 12 |
| Prepolymer | Agent | Psi/MPa | Weeks | Weeks | Weeks | Weeks | Weeks | Weeks |
| Example 3 | ¹ Polyamine | 7409 | 99 | 104 | 97 | 97 | 95 | 97 |
| Polycarbonate | | 51.0 | | | | | | |
| | ² Polyol | 3598 | 107 | 88 | — | — | — | — |
| | | 24.8 | | | | | | |
| Example 8 | ¹ Polyamine | 3002 | 83 | 72 | 68 | — | — | — |
| Polythioether | | 20.7 | | | | | | |
| | ² Polyol | 1317 | 102 | 95 | — | — | — | — |
| | | 9.1 | | | | | | |

¹ Ethacure ® 100, 75-81% 3,5-diethyltoluene-2,4-diamine, 18-24% 3,5-diethyltoluene-2,6-diamine, and 0.5-3% dialkylated m-phenylenediamines, available from Albemarle North America.
² 1,4-Cyclohexanedimethanol (CHDM) and triethanolamine.
³ Measurements discontinued due to loss of physical properties.

TABLE 6
% Elongation.

| | | Elongation (%) | | | | | | |
|---|---|---|---|---|---|---|---|---|
| | Curing | Initial/RT | 2 | 4 | 6 | 8 | 10 | 12 |
| Prepolymer | Agent | % | Weeks | Weeks | Weeks | Weeks | Weeks | Weeks |
| Example 3 | ¹ Polyamine | 254 | 97 | 101 | 90 | 98 | 97 | 93 |
| Polycarbonate | ² Polyol | 216 | 124 | 100 | — | — | — | — |
| Example 8 | ¹ Polyamine | 262 | 63 | 42 | 31 | — | — | — |
| Polythioether | ² Polyol | 156 | 60 | 33 | — | — | — | — |

¹ Ethacure ® 100, 75-81% 3,5-diethyltoluene-2,4-diamine, 18-24% 3,5-diethyltoluene-2,6-diamine, and 0.5-3% dialkylated m-phenylenediamines, available from Albemarle North America.
² 1,4-Cyclohexanedimethanol (CHDM) and triethanolamine.
³ Measurements discontinued due to loss of physical properties.

### Example 10

### Synthesis of Isocyanate-Functional Polyurethane Polycarbonate Prepolymer (10)

A 1000 mL four-neck round-bottom flask equipped with a thermometer, mechanical stirrer, nitrogen gas inlet, and condenser was charged with 400.0 gm (04029 equiv.) of Kuraray® C-2090, 20.6 gm (0.0823 equiv.) of CAPA® 4101, 15.38 gm (0.1923 equiv.) of PD-9 (3-methyl-1,5-pentane diol), 209.0 gm (1.5918 equiv.) of Desmodur® W, and 125.0 gm of methyl-N-amyl ketone. The flask was purged with nitrogen and the contents were heated to 60° C. At 60° C. 0.037 grams of dibutyl tin dilaurate was added to the reactor contents. The reaction was exothermic. The temperature was increased to 70° C. to 75° C. and maintained for two hours. After two hours, the NCO value was determined by indirect titration. The final actual NCO value was 4.93%.

### Example 11

### Synthesis of Isocyanate-Functional Polyurethane Polycarbonate Prepolymer (11)

A 1,000 mL four-neck round-bottom flask equipped with a thermometer, mechanical stirrer, nitrogen gas inlet and condenser was charged with 420.0 gm (04230 equiv.) of Kuraray® C-2090, 9.19 gm (0.0367 equiv.) of CAPA® 4101, 10.79 gm (0.1349 equiv.) of PD-9 (3-methyl-1,5-pentane diol), 154.5 gm (1.1772 equiv.) of Desmodur® W, and 198.5 gm of methyl-N-amyl ketone. The flask was purged with nitrogen and the contents were heated to 60° C. At 60° C. 0.037 grams of dibutyl tin dilaurate was added to the reactor contents. The reaction was exothermic. The temperature was increased to 70° C. to 75° C. and maintained for two hours. After two hours, the NCO value was determined by indirect titration. The final actual NCO value was 3.05%.

The crosslink density of the prepolymer of Example 10 is much higher than the prepolymer of Example 11. The hard segment content of Example 11 is 20% lower than the prepolymer of Example 10. The molecular weight of the prepolymer of Example 11 is about twice that of the prepolymer of Example 10.

### Example 12

### Properties of Isocyanate-Functional Polyurethane Polycarbonate Prepolymers

Samples of cured sealant were prepared using the isocyanate-functional polyurethane polycarbonate prepolymers of Examples 3, 10, or 11 and tested as described in Example 8.

The prepolymers were cured with Ethacure® 100 (diethyltoluene diamines (DETDA)), a blend of amines (isophorone diamine (IPDA) and trimethylhexamethylene diamine (TMDA)), or a blend of polyols (cyclohexanedimethanol (CHDM) and triethanolamine (TEA)).

The test results are presented in Tables 7 and 8.

TABLE 7
Comparative test results of isocyanate-functional
polyurethane polycarbonate prepolymers.

| | | Tensile | | | | | |
|---|---|---|---|---|---|---|---|
| Polycarbonate | | Strength | | MIL-PRF-23699 | | JP-8 | |
| Prepolymer | Curing Agent | Psi/MPa | E % | ΔM (%) | ΔV (%) | ΔM (%) | ΔV (%) |
| Example 3 | Ethacure ®- | 2418 | 36.7 | 1.48 | 5.92 | 2.33 | 9.70 |
| | 100 | 16.7 | | | | | |
| Example 3 | Amine Blend | 1860 | 30.0 | 2.46 | 8.68 | 1.87 | 7.31 |
| | | 12.8 | | | | | |
| Example 3 | Polyol Blend | 1675 | 52.9 | 1.89 | 7.18 | 1.90 | 9.04 |
| | | 11.5 | | | | | |
| Example 10 | Ethacure ®- | 2259 | 44.7 | 1.51 | 5.22 | 1.89 | 8.34 |
| | 100 | 15.6 | | | | | |
| Example 10 | Amine Blend | — | — | 1.29 | 3.88 | 0.40 | 1.27 |
| Example 10 | Polyol Blend | 1177 | 117.7 | 1.72 | 5.94 | 1.74 | 7.87 |
| | | 8.1 | | | | | |
| Example 11 | Ethacure ®- | 1646 | 118.0 | 2.30 | 7.89 | 2.27 | 9.69 |
| | 100 | 11.3 | | | | | |
| Example 11 | Amine Blend | — | — | 2.73 | 9.67 | 1.60 | 6.24 |
| Example 11 | Polyol Blend | 874 | 333.9 | 2.56 | 9.03 | 2.08 | 9.34 |
| | | 6.0 | | | | | |

¹ Not measured.

TABLE 8
Comparative test results of isocyanate-functional
polyurethane polycarbonate prepolymers.

| | | | Tensile | |
|---|---|---|---|---|
| | Prepolymer | Curing | Strength | % |
| Example | Unfilled/neat | Agent | psi/MPa | Elongation |
| 1 | Placell ® | Ethacure ® | 5791 \| 40.0 | 299 |
| | CD 220 | 100 (DETDA) | | |
| 10 | Kuraray ® | Ethacure ® | 3878 \| 26.7 | 370 |
| | C-2090 | 100 (DETDA) | | |
| 11 | Kuraray ® | Ethacure ® | 3309 \| 22.8 | 422 |
| | C-2090 | 100 (DETDA) | | |

The constituents of the thiol-terminated polyurethane prepolymers used in the experimental examples is shown in Table 9.

TABLE 9
Constituents of thiol-terminated polyurethane prepolymers.

| | | | Non-Linear | |
|---|---|---|---|---|
| | Diol | Polycaprolactone | Short Chain | |
| Example | Form at 25° C. | Polyol | Diol | Diisocyanate |
| 1 | Polycarbonate | Capa ® 4101 | ¹ PD-9 | ² H12MDI |
| | Eternacol ® PH 200D | liquid | | |
| | liquid | | | |
| 2 | Polycarbonate | Capa ® 4101 | PD-9 | H12MDI |
| | Desmophen ® C 2022 | liquid | | |
| | solid/wax | | | |
| 3 | Polycarbonate | Capa ® 4101 | PD-9 | H12MDI |
| | Placell ® CD 220 | liquid | | |
| | solid/wax | | | |
| Example 10 | Polycarbonate | Capa ® 4101 | PD-9 | H12MDI |
| | Kuraray ® C-2090 | liquid | | |
| | liquid | | | |
| Example 11 | Polycarbonate | Capa ® 4101 | PD-9 | H12MDI |
| | Kuraray ® C-2090 | liquid | | |
| | liquid | | | |
| Example 7 | Polythioether | Polythioether | BEPD | H12MDI |
| | liquid | polythiol | | |

¹ 2,4-diethyl-1,5-pentanediol.
² 4,4′-diisocyanato cyclohexylmethane.

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1-6. (canceled)

7. An isocyanate functional polyurethane prepolymer having the structure of Formula (1) the structure of Formula (1a), or a combination thereof:
—P^{a}—(I^{a}—P^{a}-)ₙ (1)
I^{b}—P^{a}—(I^{a}—P^{a})ₙ—I^{b} (1a)
wherein,
n is an integer from 1 to 50;
each I^{a} and I^{b} is independently a moiety derived from a diisocyanate I;
each polyol moiety P^{a} is independently selected from a moiety derived from a polymeric diol, a moiety derived from a non-linear short chain diol, and a moiety derived from a multifunctional polyol; wherein,
from 46 mol % to 66 mol % of the moieties P^{a} are derived from the polymeric diol,
from 4.8 mol % to 6.8 mol % of the moieties P^{a} are derived from the multifunctional polyol,
from 28 mol % to 38 mol % of the moieties P^{a} are derived from the non-linear short chain diol, and
mol % is based on the total moles of the moieties P^{a};
the diisocyanate I has the structure of Formula (6):
O═C═N—R¹—N═C═O (6)
diisocyanate moiety I^{a} has the structure of Formula (6a):
—C(═O)—NH—R¹—NH—C(═O)— (6a)
diisocyanate moiety I^{b} has the structure of Formula (6b):
—C(═O)—NH—R¹—NH—N═C═O (6b)
each polyol moiety P^{a} is independently selected from a moiety having a structure of Formula (1a), a structure of Formula (3a), and a moiety derived from a polymeric diol:
—O—R²—O— (1a)
—O—B(—OH)_{z-2}—O— (3a)
wherein,
z is an integer from 3 to 6;
R¹ is selected from C₂₋₁₀ alkanediyl, C₂₋₁₀, heteroalkanediyl, C₅₋₁₂ cycloalkanediyl, C₅₋₁₂ heterocycloalkanediyl, C₆₋₂₀ arenediyl, C₅₋₂₀ heteroarenediyl, C₆₋₂₀ alkanecycloalkanediyl, C₆₋₂₀ heteroalkanecycloalkanediyl, C₇₋₂₀ alkanearenediyl, C₇₋₂₀ heteroalkanearenediyl, substituted C₂₋₁₀ alkanediyl, substituted C₂₋₁₀, heteroalkanediyl, substituted C₅₋₁₂ cycloalkanediyl, substituted C₅₋₁₂ heterocycloalkanediyl, substituted C₆₋₂₀ arenediyl, substituted C₅₋₂₀ heteroarenediyl, substituted C₆₋₂₀ alkanecycloalkanediyl, substituted C₆₋₂₀ heteroalkanecycloalkanediyl, substituted C₇₋₂₀ alkanearenediyl, and substituted C₇₋₂₀ heteroalkanearenediyl;
R² is selected from —(C(R⁵)₂)ₛ— where s is an integer from 1 to 10; and
each R⁵ is independently be selected from hydrogen and C₁₋₆ alkyl, and at least one R⁵ is C₁₋₆ alkyl; and
B is a core of a multifunctional polyol.

8. (canceled)

9. The isocyanate-functional polyurethane prepolymer of claim 7, wherein the polymeric diol comprises:
segments derived from a non-linear diol and segments derived from a linear diol; and
the molar ratio of segments derived from a non-linear diol to segments derived from a linear diol is from 14:1 to 4:1.

10-13. (canceled)

14. The isocyanate-functional polyurethane prepolymer of claim 7, wherein the polymeric diol comprises a polycarbonate diol.

15-16. (canceled)

17. The isocyanate-functional polyurethane prepolymer of claim 14, wherein the polycarbonate diol:
comprises 3-methyl-1,5-pentane diol and the linear diol comprises 1,6-hexane diol;
has a number average molecular weight from 1,000 Daltons to 3,000 Daltons;
has a OH value from 51 to 61 KOH mg/PCD g; and
is liquid at 25° C.

18. The isocyanate-functional polyurethane prepolymer of claim 7, wherein the non-linear short chain diol has the structure:
HO—(CHR)ₙ—OH
wherein,
n is an integer from 2 to 12; and
each R is independently selected from hydrogen and C₁₋₃ alkyl.

19-24. (canceled)

25. The isocyanate-functional polyurethane prepolymer of claim 7, wherein the non-linear short chain diol comprises 2,4-diethyl-1,5-pentanediol (PD-9).

26-29. (canceled)

30. The isocyanate-functional polyurethane prepolymer of claim 7, wherein the multifunctional polyol has a hydroxyl functionality from 3 to 6.

31-33. (canceled)

34. The isocyanate-functional polyurethane prepolymer of claim 7, wherein the multifunctional polyol comprises a polycaprolactone polyol.

35-37. (canceled)

38. The isocyanate-functional polyurethane prepolymer of claim 7, wherein the diisocyanate I comprises 4,4′-methylene dicyclohexyl diisocyanate (H12MDI).

39-40. (canceled)

41. A composition comprising:
the isocyanate-functional polyurethane prepolymer of claim 7; and
a curing agent, wherein the curing agent comprises a polyamine, a polyol, or a combination thereof.

42. The composition of claim 41, wherein the curing agent comprises a polyamine.

43. The composition of claim 42, wherein the polyamine comprises an aliphatic polyamine, a cycloaliphatic polyamine, an aromatic polyamine, or a combination of any of the foregoing.

44-45. (canceled)

46. The composition of claim 42, wherein the polyamine comprises isophorone diamine and trimethyl hexamethylene diamine.

47-59. (canceled)

60. A coating system comprising:
a first component, wherein the first component comprises the isocyanate-functional polyurethane prepolymer of claim 7; and
a second component, wherein the second component comprises a curing agent, wherein the curing agent comprises a polyamine, a polyol, or a combination thereof.

61. The coating system of claim 60, wherein the second component comprises a polyamine or a polyol.

62-65. (canceled)

66. A method of coating a surface comprising applying a coating composition comprising the isocyanate-functional polyurethane prepolymer of claim 7 or the composition of claim 41 onto a substrate to provide an applied coating composition.

67-68. (canceled)

69. A part comprising a coating prepared from the composition of claim 7.

70-71. (canceled)
